(19) United States
(12) Patent Application Publication
(10) Pub. No.: US 2025/0141635 A1
(43) Pub. Date: May 1, 2025

(54) METHOD AND DEVICE FOR GENERATING AND TRANSMITTING HARQ-ACK CODEBOOK IN WIRELESS COMMUNICATION SYSTEM

(71) Applicant: SAMSUNG ELECTRONICS CO., LTD., Suwon-si (KR)

(72) Inventors: Kyungjun CHOI, Suwon-si (KR); Younsun KIM, Suwon-si (KR); Jaeyeon SHIM, Suwon-si (KR); Hyoungju JI, Suwon-si (KR)

(21) Appl. No.: 18/930,836

(22) Filed: Oct. 29, 2024

(30) Foreign Application Priority Data
Oct. 30, 2023 (KR) 10-2023-0147039

(51) Int. Cl. H04L 5/00; H04W 72/0446; H04W 72/23

(52) U.S. Cl. CPC H04L 5/0055; H04W 72/0446; H04W 72/23

(57) ABSTRACT

The disclosure provides a method for establishing and receiving a downlink control channel in a wireless communication system. A method performed by a terminal comprises, receiving, from a base station, information with at least one cell associated with a hybrid automatic repeat request acknowledgement (HARQ-ACK) codebook transmission of the UE; receiving, from the base station, information triggering the HARQ-ACK codebook transmission; and transmitting, to the base station, a HARQ-ACK codebook including HARQ-ACK information associated with the at least one cell, respectively, wherein, in case that the at least one cell includes at least one of a deactivated secondary cell (SCell) or an activated SCell including an activated dormant bandwidth part (BWP), HARQ-ACK information associated with the deactivated SCell and HARQ-ACK information associated with the activated SCell including the activated dormant BWP is generated based on a parameter associated with a HARQ-ACK information generation, which is configured for reference BWP.

### CROSS-REFERENCE TO RELATED APPLICATION

This application is based on and claims priority under 35 U.S.C. § 119 to Korean Patent Application No. 10-2023-0147039, filed on Oct. 30, 2023, in the Korean Intellectual Property Office, the disclosure of which is herein incorporated by reference in its entirety.

### BACKGROUND

### 1. Field

The disclosure relates to operations of a UE and a base station in a wireless communication system. More specifically, the disclosure relates to a method and a device for generating a HARQ-ACK codebook in case that Scell deactivation or Scell dormancy is indicated to a UE.

### 2. Description of Related Art

5G mobile communications technology defines a wide range of frequency bands to enable faster transmission speeds and new services, and can be implemented in the sub-6 GHz (“Sub 6 GHz”) bands, such as 3.5 gigahertz (3.5 GHZ), as well as in the ultra-high frequency bands called millimeter wave (“Above 6 GHZ”), such as 28 GHz and 39 GHz. In addition, for 6G mobile communications technology, also known as Beyond 5G systems, implementations in the terahertz band (e.g., the 3 terahertz (3 THz) band at 95 GHz) are being considered to achieve 50 times faster transmission speeds and ultra-low latency of one-tenth the speed of 5G mobile communications technology.

In the early stages of 5G mobile communications technology, beamforming and massive array multiple input/output (Massive MIMO) to mitigate the path loss of radio waves in the ultra-high frequency band and increase the transmission distance of radio waves, with the goal of supporting services and meeting the performance requirements for enhanced Mobile BroadBand (eMBB), Ultra-Reliable Low-Latency Communications (URLLC), and massive Machine-Type Communications (mMTC), Support for various pneumatologies for efficient utilization of ultra-high frequency resources (such as multiple subcarrier spacing operations) and dynamic operations for slot formats, early access technologies to support multi-beam transmission and broadband, and the definition and operation of band-width parts (BWPs), standardization of new channel coding methods such as Low Density Parity Check (LDPC) coding for large data transfers and Polar Code for reliable transmission of control information; L2 pre-processing; and Network Slicing, which provides dedicated networks for specific services.

Currently, discussions are underway to improve and enhance the initial 5G mobile communications technology in light of the services it was intended to support, such as Vehicle-to-Everything (V2X) to help autonomous vehicles make driving decisions based on their own location and status information transmitted by the vehicle and increase user convenience, Physical layer standardization is underway for technologies such as New Radio Unlicensed (NR-U), NR terminal low power consumption technology (UE Power Saving), Non-Terrestrial Network (NTN), which is a direct terminal-to-satellite communication for coverage in areas where communication with terrestrial networks is not possible, and Positioning.

In addition, intelligent factories (Industrial Internet of Things, IIoT) to support new services through connectivity and convergence with other industries; Integrated Access and Backhaul (IAB) to provide nodes for network coverage area expansion by integrating wireless backhaul links and access links; and Mobility Enhancement technologies, including Conditional Handover and Dual Active Protocol Stack (DAPS) handover, Standardization is also underway in the area of air interface architecture/protocols for technologies such as 2-step RACH for NR, which simplifies the random access process; 5G baseline architecture (e.g., Service based Architecture, Service based Interface) for the convergence of Network Functions Virtualization (NFV) and Software-Defined Networking (SDN) technologies; and system architecture/services for Mobile Edge Computing (MEC), where services are delivered based on the location of the terminal.

Once these 5G mobile communication systems are commercialized, an explosive growth of connected devices will be connected to the communication network, which is expected to require enhancement of the functions and performance of 5G mobile communication systems and integrated operation of connected devices. To this end, new research will be conducted on improving 5G performance and reducing complexity by utilizing extended Reality (XR), Artificial Intelligence (AI), and Machine Learning (ML) to efficiently support Augmented Reality (AR), Virtual Reality (VR), and Mixed Reality (MR), supporting AI services, supporting Metaverse services, and drone communication.

In addition, these advances in 5G mobile communications systems will be supported by new waveforms to ensure coverage in the terahertz band of 6G mobile communications technology, and multi-antenna transmission technologies such as Full Dimensional MIMO (FD-MIMO), Array Antenna, and Large Scale Antenna, Metamaterial-based lenses and antennas, high-dimensional spatial multiplexing techniques using Orbital Angular Momentum (OAM), and Reconfigurable Intelligent Surface (RIS) technologies to improve coverage of terahertz band signals, Full Duplex technology to improve frequency efficiency and system network of 6G mobile communication technology; AI-based communication technology that utilizes satellites and artificial intelligence (AI) from the design stage and realizes system optimization by embedding end-to-end AI support functions; and next-generation distributed computing technology that realizes complex services beyond the limits of terminal computing capabilities by utilizing ultra-high-performance communication and computing resources.

As a result of the above and the development of wireless communication systems, various services can be provided, and measures are required to provide these services smoothly.

### SUMMARY

A disclosed embodiment may provide a device and a method capable of effectively providing a service in a wireless communication system.

The present disclosure is intended to address the above issues, a method performed by a user equipment (UE) in a wireless communication system, the method comprising: receiving, from a base station, information with at least one cell associated with a hybrid automatic repeat request acknowledgement (HARQ-ACK) codebook transmission of the UE; receiving, from the base station, information triggering the HARQ-ACK codebook transmission; and transmitting, to the base station, a HARQ-ACK codebook including HARQ-ACK information associated with the at least one cell, respectively, wherein, in case that the at least one cell includes at least one of a deactivated secondary cell (SCell) or an activated SCell including an activated dormant bandwidth part (BWP), HARQ-ACK information associated with the deactivated SCell and HARQ-ACK information associated with the activated SCell including the activated dormant BWP is generated based on a parameter associated with a HARQ-ACK information generation, which is configured for a reference BWP.

Furthermore, in the present disclosure, a method performed by a base station in a wireless communication system, the method comprising: transmitting, to a user equipment (UE), information with at least one cell associated with a hybrid automatic repeat request acknowledgement (HARQ-ACK) codebook transmission of the UE; transmitting, to the UE, information triggering the HARQ-ACK codebook transmission; and receiving, from the UE, a HARQ-ACK codebook including HARQ-ACK information associated with the at least one cell, respectively, wherein, in case that the at least one cell includes at least one of a deactivated secondary cell (SCell) or an activated SCell including an activated dormant bandwidth part (BWP), HARQ-ACK information associated with the deactivated SCell and HARQ-ACK information associated with the activated SCell including the activated dormant BWP is generated based on a parameter associated with a HARQ-ACK information generation, which is configured for a reference BWP.

Furthermore, in the present disclosure, a user equipment (UE) in a wireless communication system, the UE comprising: a transceiver; and a controller couple with the transceiver and configured to: receive, from a base station, information with at least one cell associated with a hybrid automatic repeat request acknowledgement (HARQ-ACK) codebook transmission of the UE, receive, from the base station, information triggering the HARQ-ACK codebook transmission, and transmit, to the base station, a HARQ-ACK codebook including HARQ-ACK information associated with the at least one cell, respectively, wherein, in case that the at least one cell includes at least one of a deactivated secondary cell (SCell) or an activated SCell including an activated dormant bandwidth part (BWP), HARQ-ACK information associated with the deactivated SCell and HARQ-ACK information associated with the activated SCell including the activated dormant BWP is generated based on a parameter associated with a HARQ-ACK information generation, which is configured for a reference BWP.

Furthermore, in the present disclosure, a base station in a wireless communication system, the base station comprising: a transceiver; and a controller couple with the transceiver and configured to: transmit, to a user equipment (UE), information with at least one cell associated with a hybrid automatic repeat request acknowledgement (HARQ-ACK) codebook transmission of the UE, transmit, to the UE, information triggering the HARQ-ACK codebook transmission, and receiving, from the UE, a HARQ-ACK codebook including HARQ-ACK information associated with the at least one cell, respectively, wherein, in case that the at least one cell includes at least one of a deactivated secondary cell (SCell) or an activated SCell including an activated dormant bandwidth part (BWP), HARQ-ACK information associated with the deactivated SCell and HARQ-ACK information associated with the activated SCell including the activated dormant BWP is generated based on a parameter associated with a HARQ-ACK information generation, which is configured for a reference BWP.

A disclosed embodiment advantageously provides a device and a method capable of effectively providing a service in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates an example of a control resource set configuration of a downlink control channel in a wireless communication system;

FIG. 5 illustrates a structure of a downlink control channel in a wireless communication system according to an embodiment of the disclosure;

FIG. 6 illustrates a method in which a base station and a UE transmit/receive data in consideration of a downlink data channel and a rate matching resource in a wireless communication system according to an embodiment of the disclosure;

FIG. 7 illustrates an example of frequency domain resource allocation with regard to a physical downlink shared channel (PDSCH) in a wireless communication system according to an embodiment of the disclosure;

FIG. 8 illustrates an example of time domain resource allocation with regard to a PDSCH in a wireless communication system according to an embodiment of the disclosure;

FIG. 9 illustrates an example of time domain resource allocation according to a subcarrier spacing with regard to a data channel and a control channel in a wireless communication system according to an embodiment of the disclosure;

FIG. 10 illustrates radio protocol structures of a base station and a UE in single cell, carrier aggregation, and dual connectivity situations according to an embodiment of the disclosure;

FIG. 11A-11C illustrate a Type-1 HARQ-ACK codebook according to an embodiment of the disclosure;

FIG. 12 illustrates a Type-3 HARQ-ACK codebook according to an embodiment of the disclosure;

FIG. 13 illustrates a flowchart of a method for acquiring parameters according to an embodiment of the disclosure;

FIG. 14 illustrates a case in which a BWP change is indicated by DCI that schedules a PDSCH according to an embodiment of the disclosure;

FIG. 15 illustrates a structure of a UE in a wireless communication system according to an embodiment of the disclosure; and

FIG. 16 illustrates a structure of a base station in a wireless communication system according to an embodiment of the disclosure.

### DETAILED DESCRIPTION

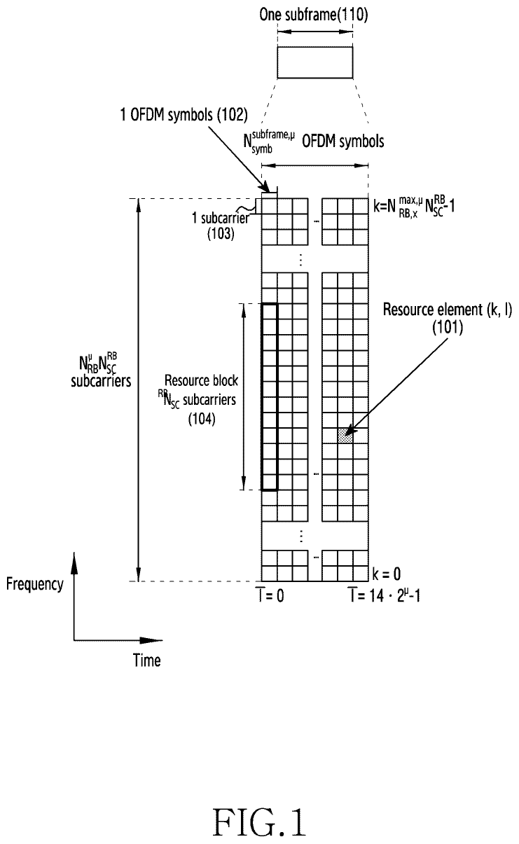

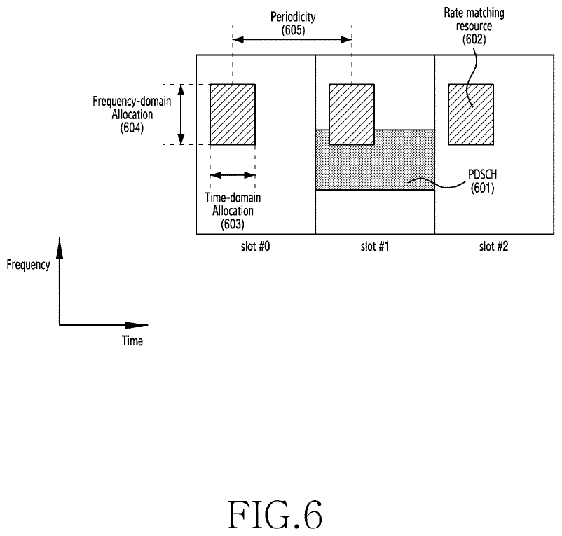

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the disclosure.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104.

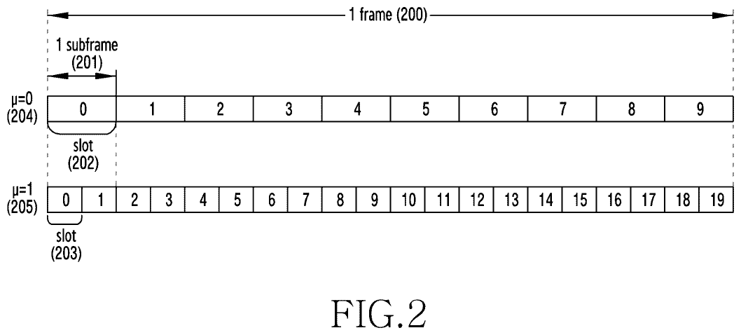

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (for example, the number N_{symb}^{slot} of symbols for one slot may be 14). One subframe 201 may include one or multiple slots 202 and 203, and the number of slots 202 and 203 per one subframe 201 may vary depending on configuration values μ for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number Nₛₗₒₜ^{subframe,μ} of slots per one subframe may change according to a configuration value u for a subcarrier spacing, and the number Nₛₗₒₜ^{frame,μ} of slots per one frame may change accordingly. Nₛₗₒₜ^{subframe,μ} slot and Nₛₗₒₜ^{frame,μ} may be defined according to each subcarrier spacing configuration u as in Table 1 below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, bandwidth part (BWP) configuration in a 5G communication system will be described in detail with reference to the accompanying drawings.

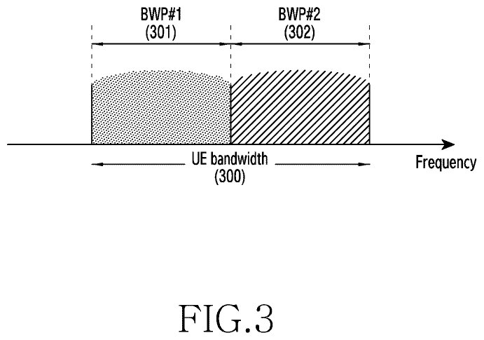

FIG. 3 illustrates an example of a bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, |

```
    n5},
    (subcarrier spacing)
```

| | |
|---|---|
| cyclicPrefix | ENUMERATED { extended } |

(cyclic prefix)
}

Obviously, the above example is not limiting, and various parameters related to the bandwidth part may be configured for the UE, in addition to the above configuration information. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource set #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to some embodiments, the bandwidth part configuration may be used to support the case where the bandwidth supported by the UE is smaller than the system bandwidth. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given in Table 3 below, for example.

TABLE 3

| | | BWP switch delay T_{BWP} (slots) | |
|---|---|---|---|
| μ | NR Slot length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. If the base station wants to schedule a data channel by using the new bandwidth part, the base station may determine time domain resource allocation regarding the data channel, based on the UE's bandwidth part change delay time (T_{BWP}). For example, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [SS/PBCH Block]

Next, synchronization signal (SS)/PBCH blocks in 5G will be described.

An SS/PBCH block may refer to a physical layer channel block including a primary synchronization signal (PSS), a secondary synchronization signal (SSS), and a PBCH. Details thereof are as follows.
PSS: a signal which becomes a reference of downlink time/frequency synchronization, and provides partial information of a cell ID.
SSS: becomes a reference of downlink time/frequency synchronization, and provides remaining cell ID information not provided by the PSS. Additionally, the SSS may serve as a reference signal for PBCH demodulation of a PBCH.
PBCH: provides an MIB which is mandatory system information necessary for the UE to transmit/receive data channels and control channels. The mandatory system information may include search space-related control information indicating a control channel's radio resource mapping information, scheduling control information regarding a separate data channel for transmitting system information, and the like.
SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and control resource set #0 are quasi-co-located (QCL). The UE may receive system information with downlink control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that control resource set #0 associated therewith is monitored.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through or on a physical downlink control channel (PDCCH). A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and thereby may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

TABLE 4
Identifier for DCI formats - [1] bit
Frequency domain resource assignment -[┌log₂(N_{RB}^{UL, BWP}(N_{RB}^{UL, BWP} + 1)/2)┐] bits
Time domain resource assignment - X bits
Frequency hopping flag - 1 bit.
Modulation and coding scheme - 5 bits
New data indicator - 1 bit
Redundancy version - 2 bits
HARQ process number - 4 bits
Transmit power control (TPC) command for scheduled PUSCH- [2] bits
Uplink/supplementary uplink indicator (UL/SUL indicator) - 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

```
TABLE 5
- Carrier indicator − 0 or 3 bits
- UL/SUL indicator − 0 or 1 bit
- Identifier for DCI formats − [1] bits
- Bandwidth part indicator − 0, 1 or 2 bits
- Frequency domain resource assignment
    • For resource allocation type 0, ┌N_{RB}^{UL,BWP}/P┐ bits
    • For resource allocation type 1, ┌log₂(N_{RB}^{UL,BWP}(N_{RB}^{UL,BWP} +
    1)/2┐ bits
- Time domain resource assignment −1, 2, 3, or 4 bits
- Virtual resource block-to-physical resource block (VRB-to-PRB)
mapping − 0 or 1 bit, only for resource allocation type 1.
    • 0 bit if only resource allocation type 0 is configured;
    • 1 bit otherwise.
- Frequency hopping flag − 0 or 1 bit, only for resource allocation type 1.
    • 0 bit if only resource allocation type 0 is configured;
    • 1 bit otherwise.
- Modulation and coding scheme − 5 bits
- New data indicator − 1 bit
- Redundancy version − 2 bits
- HARQ process number − 4 bits
- 1st downlink assignment index− 1 or 2 bits
    • 1 bit for semi-static HARQ-ACK codebook;
    • 2 bits for dynamic HARQ-ACK codebook with single HARQ-ACK
    codebook.
- 2nd downlink assignment index − 0 or 2 bits
    • 2 bits for dynamic HARQ-ACK codebook with two HARQ-ACK
    sub-codebooks;
    • 0 bit otherwise.
- TPC command for scheduled PUSCH − 2 bits
$\text{} \begin{matrix}‐ SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ \\ bits\end{matrix}$
    $\text{} \begin{matrix} ⌈ {log}_{2} ( {\sum }_{k = 1}^{{L}_{max}} ( \begin{matrix}{N}_{SRS} \\ k\end{matrix} ) ) ⌉ bits for non ‐ codebook based \\ PUSCH transmission ;\end{matrix}$
    • ┌log₂(N_{SRS})┐ bits for codebook based PUSCH transmission.
- Precoding information and number of layers−up to 6 bits
- Antenna ports − up to 5 bits
- SRS request − 2 bits
- CSI request − 0, 1, 2, 3, 4, 5, or 6 bits
- Code block group (CBG) transmission information − 0, 2, 4, 6, or 8 bits
- Phase tracking reference signal (PTRS)-demodulation reference signal
(DMRS) association− 0 or 2 bits.
- beta_offset indicator− 0 or 2 bits
- DMRS sequence initialization− 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

TABLE 6
Identifier for DCI formats - [1] bit
Frequency domain resource assignment -[┌log₂(N_{RB}^{DL, BWP}(N_{RB}^{DL, BWP} + 1)/2) ┐] bits
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
Physical uplink control channel (PUCCH) resource indicator- 3 bits
PDSCH-to-HARQ feedback timing indicator- [3] bits

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

TABLE 7

| Carrier indicator - 0 or 3 bits | |
|---|---|
| Identifier for DCI formats - [1] bits | |
| Bandwidth part indicator - 0, 1 or 2 bits | |
| Frequency domain resource assignment | |
| | For resource allocation type 0, ┌N_{RB}^{DL, BWP}/P┐bits |
| | For resource allocation type 1, ┌log₂(N_{RB}^{DL, BWP}(N_{RB}^{DL, BWP} + 1)/2) ┐bits |
| Time domain resource assignment -1, 2, 3, or 4 bits | |
| VRB-to-PRB mapping - 0 or 1 bit, only for resource allocation type 1. | |
| | 0 bit if only resource allocation type 0 is configured; |
| | 1 bit otherwise. |

PRB bundling size indicator - 0 or 1 bit
Rate matching indicator - 0, 1, or 2 bits
ZP CSI-RS trigger - 0, 1, or 2 bits

For transport block 1:

Modulation and coding scheme - 5 bits
New data indicator - 1 bit
Redundancy version - 2 bits

For transport block 2:

Modulation and coding scheme - 5 bits
New data indicator - 1 bit
Redundancy version - 2 bits
HARQ process number - 4 bits
Downlink assignment index - 0 or 2 or 4 bits
TPC command for scheduled PUCCH - 2 bits
PUCCH resource indicator - 3 bits
PDSCH-to-HARQ_feedback timing indicator - 3 bits
Antenna ports - 4, 5 or 6 bits
Transmission configuration indication- 0 or 3 bits
SRS request - 2 bits
CBG transmission information - 0, 2, 4, 6, or 8 bits
CBG flushing out information - 0 or 1 bit
DMRS sequence initialization - 1 bit

### [PDCCH: CORESET, REG, CCE, and Search Space]

Hereinafter, a downlink control channel in a 5G communication system will be described in more detail with reference to the accompanying drawings.

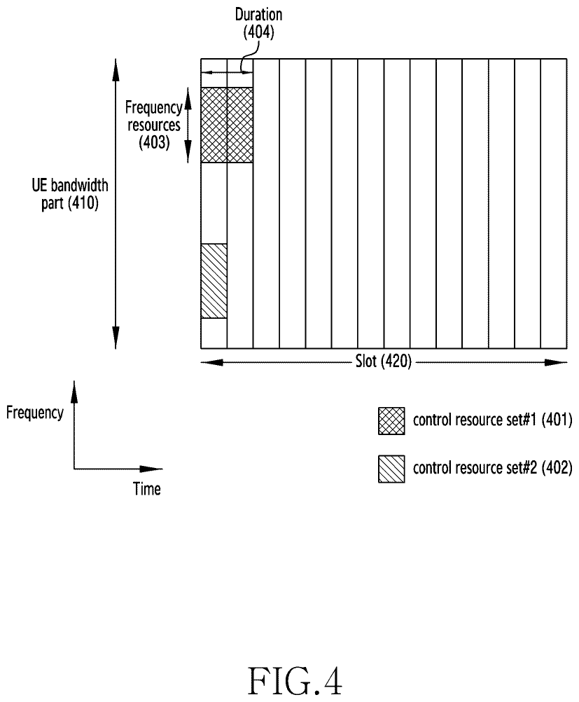

FIG. 4 illustrates an example of a control resource set (CORESET) used to transmit a downlink control channel in a 5G wireless communication system. FIG. 4 illustrates an example in which a UE bandwidth part 410 is configured along the frequency axis, and two CORESETs (CORESET #1 420 and CORESET #2 401) are configured within one slot 402 along the time axis. The control resource sets 401 and 402 may be configured in a specific frequency resource 410 within the entire UE bandwidth part 403 along the frequency axis. The control resource sets 401 and 402 may be each configured as one or multiple OFDM symbols along the time domain, and the number of the OFDM symbols may be defined as a control resource set duration 404. Referring to the example illustrated in FIG. 4, control resource set #1 401 is configured to have a control resource set duration corresponding to two symbols, and control resource set #2 402 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the control resource set may include the following pieces of information: given in Table 8 below.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity))

| | |
|---|---|
| frequencyDomainResources | BIT STRING (SIZE (45)), |

(frequency domain resource assignment information)

| | |
|---|---|
| duration | INTEGER |

```
      (1..maxCoReSetDuration),
  (time domain resource assignment information)
      cce-REG-MappingType
        CHOICE {
  (CCE-to-REG mapping type)
        interleaved
        SEQUENCE {
            reg-BundleSize
        ENUMERATED {n2, n3, n6},
      (REG bundle size)
            precoderGranularity
        ENUMERATED {sameAsREG-bundle, allContiguousRBs},
            interleaverSize
        ENUMERATED {n2, n3, n6}
            (interleaver size)
            shiftIndex
        INTEGER(0..maxNrofPhysicalResourceBlocks−1)
                OPTIONAL
          (interleaver shift)
    },
```

| | |
|---|---|
| nonInterleaved | NULL |

```
      },
      tci-StatesPDCCH
        SEQUENCE(SIZE (1..maxNrofTCI-StatesPDCCH)) OF TCI-StateId
            OPTIONAL,
  (QCL configuration information)
```

| | |
|---|---|
| tci-PresentInDCI | ENUMERATED {enabled} |

OPTIONAL, -- Need S
}

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set.

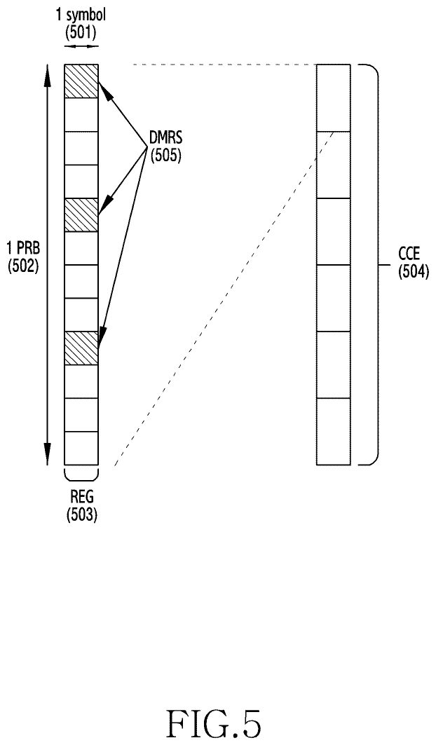

FIG. 5 illustrates an example of a basic unit of time and frequency resources constituting a downlink control channel available in a 5G system. According to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element 504 as illustrated in FIG. 5, one CCE 504 may include multiple REGs 503. To describe the REG 503 illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs may be defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the information configured for the UE by the base station may include the following pieces of information in Table 9 below.

TABLE 9

| | |
|---|---|
| SearchSpace ::= | SEQUENCE { |

```
      -- Identity of the search space. SearchSpaceId = 0 identifies the SearchSpace
      configured via PBCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

```
  (monitoring slot level periodicity)
        sl1
        NULL,
        sl2
        INTEGER (0..1),
        sl4
        INTEGER (0..3),
        sl5
        INTEGER (0..4),
        sl8
        INTEGER (0..7),
        sl10
        INTEGER (0..9),
        sl16
        INTEGER (0..15),
        sl20
        INTEGER (0..19)
      }
        OPTIONAL,
  duration(monitoring duration)  INTEGER (2..2559)
```

| | |
|---|---|
| monitoringSymbolsWithinSlot | BIT STRING |

```
      (SIZE (14))
          OPTIONAL,
  (monitoirng symbols within slot)
      nrofCandidates
        SEQUENCE {
  (number of PDCCH candidates for each aggregation level)
        aggregationLevel1
        ENUMERATED {n0, n1, n2, n3, n4, n5, n6, n8},
        aggregationLevel2
        ENUMERATED {n0, n1, n2, n3, n4, n5, n6, n8},
        aggregationLevel4
        ENUMERATED {n0, n1, n2, n3, n4, n5, n6, n8},
        aggregationLevel8
        ENUMERATED {n0, n1, n2, n3, n4, n5, n6, n8},
        aggregationLevel16
        ENUMERATED {n0, n1, n2, n3, n4, n5, n6, n8}
      },
```

| | |
|---|---|
| searchSpaceType | CHOICE { |

```
      (search space type)
        -- Configures this search space as common search space (CSS) and DCI
      formats to monitor.
        common
        SEQUENCE {
      (common search space)
    }
        ue-Specific
        SEQUENCE {
      (UE-specific search space)
          -- Indicates whether the UE monitors in this USS for DCI formats 0-0
      and 1-0 or for formats 0-1 and 1-1.
          formats
        ENUMERATED {formats0-0-And-1-0, formats0-1-And-1-1},
          ...
}
```

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Of course, the combinations of DCI formats and RNTIs monitored in a common search space are not limited to the examples given below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Of course, the combinations of DCI formats and RNTIs monitored in a UE-specific search space are not limited to the examples given below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs enumerated above may follow the definition and usage given below.
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI) for indicating power control command for PUCCH
Transmit power control for SRS RNTI (TPC-SRS-RNTI): used to indicate a power control command regarding an SRS

The DCI formats enumerated above may follow the definitions given in Table 10 below, for example.

TABLE 10

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In 5G, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}-1: PDCCH candidate index at aggregation level L
i=0, . . . , L-1
Y_{p,n}_{_{s,f}}_{^{μ}}=(Aₚ·Y_{p,n}_{_{s,f}}_{^{μ}}-1) mod D, Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [PDSCH/PUSCH: Regarding Time Resource Allocation]

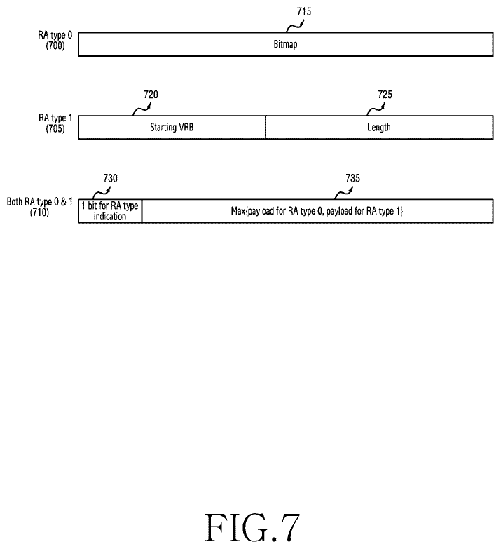

FIG. 7 illustrates an example of frequency domain resource allocation with regard to a physical downlink shared channel (PDSCH) or physical uplink shared channel (PUSCH) in a wireless communication system according to an embodiment of the disclosure.

FIG. 7 illustrates three frequency domain resource allocation methods of type-0 700, type-1 705, and dynamic switch 710 which can be configured through an upper layer in an NR wireless communication system.

Referring to FIG. 7, in the case in which a UE is configured to use only resource allocation type-0 through upper layer signaling (700), partial downlink control information (DCI) for allocating a PDSCH to the UE includes a bitmap 715 including N_{RBG} bits. Here, N_{RBG} may refer to the number of resource block groups (RBGs) determined according to the BWP size allocated by a BWP indicator and upper layer parameter rbg-Size, as in Table 11 below, and data is transmitted in RBGs indicated as “1” by the bitmap.

TABLE 11

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

The BWP size refers to the number of RBs included in a BWP. More specifically, if resource allocation type-0 is indicated, the length of a frequency domain resource assignment (FDRA) field of DCI received by the UE is equal to the number N_{RBG} of RBGs, and N_{RBG}=┌(N_{BWP}^{size}+(N_{BWP}^{start} mod P))/P┐. Here, the first RBG includes RBG₀^{size}=P−N_{BWP}^{size} mod P RBs, and the last RBG include RBGₗₐₛₜ^{size}=(N_{BWP}^{start}+N_{BWP}^{size}) mod P RBs if N_{BWP}^{start}+N_{BWP}^{size}) mod P>0 and otherwise, includes RBGₗₐₛₜ^{size}=P RBs. The other RBGs each include P RBs. Here, P refers to the number of nominal RBGs as determined according to Table 11.

If the UE is configured to use only resource allocation type-1 through higher layer signaling (705), some DCI for allocating PDSCHs to the UE may include frequency domain resource allocation information including [log₂(N_{RB}^{DL,BWP}(N_{RB}^{DL,BWP}+1)/2] bits. Here, N_{RB}^{BWP} denotes the number of RBs included in a BWP. The base station may thereby configure a starting virtual resource block (starting VRB) 720 and the length 725 of a frequency domain resource allocated continuously therefrom.

In the case in which the UE is configured to use both resource allocation type-0 and resource allocation type-1 through upper layer signaling (710), partial DCI for allocating a PDSCH to the corresponding UE includes frequency domain resource allocation information including as many bits as the larger value 735 between the payload 715 for configuring resource allocation type-0 and the payload 720 and 725 for configuring resource allocation type-1. The conditions for this will be described again later. One bit may be added to the foremost part (MSB) of the frequency domain resource allocation information inside the DCI, and if the bit has the value of “0”, use of resource allocation type-0 may be indicated, and if the bit has the value of “1”, use of resource allocation type-1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations-16 entries may be configured for the PDSCH, and a table including a maximum of maxNrofUL-Allocations-16 entries may be configured for the PUSCH. According to an embodiment, the time domain resource allocation information may include at least one of PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter labeled K2), information regarding the location and length of the start symbol by which a PDSCH or PUSCH is scheduled inside a slot, and the mapping type of a PDSCH or PUSCH. For example, information such as in Table 12 or Table 13 below may be transmitted from the base station to the UE.

TABLE 12
PDSCH-TimeDomainResourceAllocationList information element

```
    PDSCH-TimeDomainResourceAllocationList  ::=  SEQUENCE  (SIZE(1..maxNrofDL-
Allocations)) OF
    PDSCH-TimeDomainResourceAllocation
    PDSCH-TimeDomainResourceAllocation ::=  SEQUENCE {
```

| | |
|---|---|
| k0 | INTEGER(0..32) |

```
    OPTIONAL, -- Need S
        (PDCCH-to-PDSCH timing, slot unit)
```

| | |
|---|---|
| mappingType | ENUMERATED {typeA, typeB}, |

(PDSCH mapping type)

| | |
|---|---|
| startSymbolAndLength | INTEGER (0..127) |

```
      (start symbol and length of PDSCH)
  }
```

TABLE 13
PUSCH-TimeDomainResourceAllocationList information element

```
  PUSCH-TimeDomainResourceAllocationList  ::=  SEQUENCE  (SIZE(1..maxNrofUL-
Allocations)) OF
  PUSCH-TimeDomainResourceAllocation
  PUSCH-TimeDomainResource Allocation ::=  SEQUENCE {
```

| | |
|---|---|
| k2 | INTEGER(0..32) OPTIONAL, -- Need |

S
(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |
| (start symbol and length of PUSCH) | |
| } | |

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

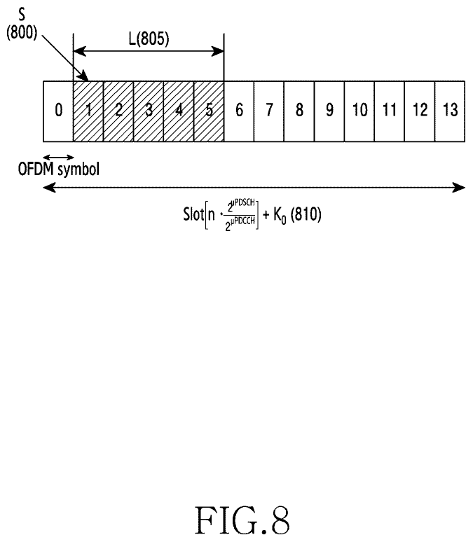

FIG. 8 illustrates an example of time domain resource allocation with regard to a PDSCH in a wireless communication system according to an embodiment of the disclosure.

Referring to FIG. 8, the UE may indicate the time domain location of a PDSCH resource according to the subcarrier spacing (SCS) (μPDSCH, μPDCCH) of a data channel and a control channel configured by using an upper layer, the scheduling offset (K0) value, and the OFDM symbol start location 800 and length 805 within one slot dynamically indicated through DCI.

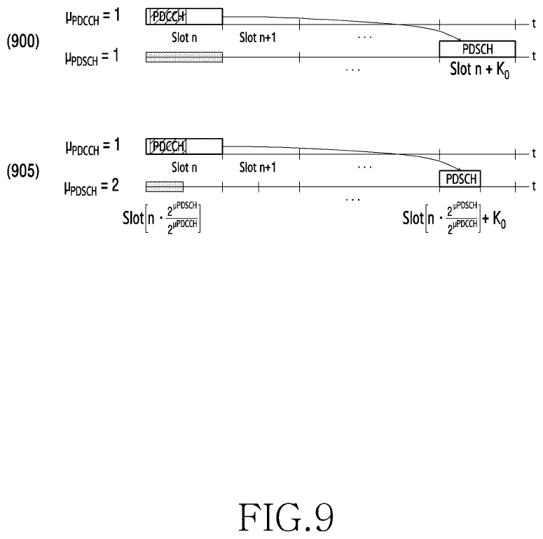

FIG. 9 illustrates an example of time domain resource allocation according to a subcarrier spacing with regard to a data channel and a control channel in a wireless communication system according to an embodiment of the disclosure.

Referring to FIG. 9, if the data channel and the control channel have the same subcarrier spacing (900, μ_{PDSCH}=μ_{PDCCH}), the slot number for data and that for control are identical, and the base station and the UE may accordingly generate a scheduling offset in conformity with a predetermined slot offset K0. On the other hand, if the data channel and the control channel have different subcarrier spacings (905, μ_{PDSCH} #μ_{PDCCH}), the slot number for data and that for control are different, and the base station and the UE may accordingly generate a scheduling offset in conformity with a predetermined slot offset K0 with reference to the subcarrier spacing of the PDCCH.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 14 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 14 through upper signaling. If PUSCH transmission is operated by a configured grant, parameters applied to the PUSCH transmission are applied through configuredGrantConfig (upper signaling) in Table 14 except for dataScramblingIdentityPUSCH, txConfig, codebookSubset, maxRank, and scaling of UCI-OnPUSCH, which are provided by pusch-Config (upper signaling) in Table 15. If provided with transformPrecoder inside configuredGrantConfig (upper signaling) in Table 14, the UE applies tp-pi2BPSK inside pusch-Config in Table 15 to PUSCH transmission operated by a configured grant.

TABLE 14

| | |
|---|---|
| ConfiguredGrantConfig ::= | SEQUENCE { |

| | |
|---|---|
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |

| | |
|---|---|
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |

| | |
|---|---|
| dmrs-SeqInitialization | INTEGER (0..1) |

OPTIONAL, -- Need R

| | |
|---|---|
| precodingAndNumberOfLayers | INTEGER (0..63), |

| | |
|---|---|
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1..maxNrofPhysicalResourceBlocks− |

1) OPTIONAL, -- Need R

| | |
|---|---|
| pathlossReferenceIndex | INTEGER (0..maxNrofPUSCH- |

PathlossReferenceRSs−1),
...

| | |
|---|---|
| } | OPTIONAL, |

-- Need R
...
}

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 15, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 15, the UE does not expect scheduling through DCI format 0_1.

TABLE 15

| | |
|---|---|
| PUSCH-Config ::= | SEQUENCE { |

| | |
|---|---|
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks−1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

| | |
|---|---|
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent, nonCoherent}
OPTIONAL, -- Cond codebookBased

| | | |
|---|---|---|
| maxRank | INTEGER (1..4) | OPTIONAL, |

-- Cond codebookBased

| | | |
|---|---|---|
| rbg-Size | ENUMERATED { config2} | OPTIONAL, |

-- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Hereinafter, codebook-based PUSCH transmission will be described. The codebook-based PUSCH transmission may be dynamically scheduled through DCI format 0_0 or 0_1, and may be semi-statically operated by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent” as UE capability, the UE does not expect that the value of codebookSubset (upper signaling) will be configured as “fullyAndPartialAndNonCoherent”. In addition, if the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. As described above, PUSCH transmission may be dynamically scheduled through DCI format 0_0 or 0_1, and may be semi-statically configured by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### [Regarding CA/DC]

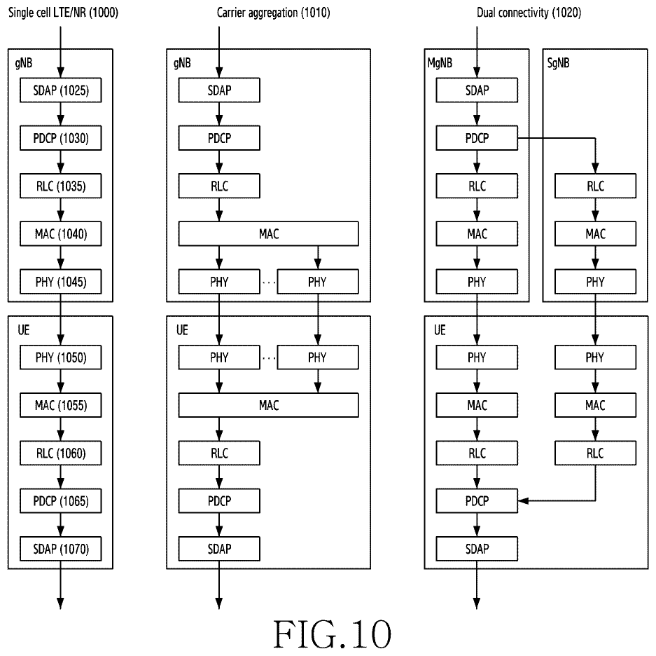

FIG. 10 illustrates radio protocol structures of a base station and a UE in single cell, carrier aggregation, and dual connectivity situations according to an embodiment of the disclosure.

Referring to FIG. 10, the radio protocol of a next-generation mobile communication system includes an NR service data adaptation protocol (SDAP) 1025 or 1070, an NR packet data convergence protocol (PDCP) 1030 or 1065, an NR radio link control (RLC) 1035 or 1060, and an NR medium access controls (MAC) 1040 or 1055, on each of UE and NR base station sides.

The main functions of the NR SDAP 1025 or 1070 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QOS) reflection configuration 1-bit indicator (NAS reflective QoS) of the SDAP header and the access stratum (AS) QOS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1030 or 1065 may include some of the following functions: below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include at least one of a function of instantly transferring data without considering the order, a function of recording PDCP PDUs lost as a result of reordering, a function of reporting the state of the lost PDCP PDUs to the transmitting side, and a function of requesting retransmission of the lost PDCP PDUs.

The main functions of the NR RLC 1035 or 1060 may include some of the following functions: below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device refers to a function of delivering RLC SDUs, received from the lower layer, to the upper layer in sequence. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs. The in-sequence delivery function of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The above-mentioned out-of-sequence delivery of the NR RLC device refers to a function of directly delivering RLC SDUs received from the lower layer to the upper layer regardless of the sequence. The out-of-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, and a function of storing the RLC SN or PDCP SN of received RLC PDUs, and recording RLC PDUs lost as a result of reordering.

The NR MAC 1040 or 1055 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1045 or 1050 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 1000. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 1010. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 1020.

Referring to the above description relating to the PDCCH and beam configuration, PDCCH repetitive transmission is not supported in current Rel-15 and Rel-16 NR, and it may be thus difficult to achieve required reliability in a scenario requiring high reliability, such as URLLC. The disclosure may improve the PDCCH reception reliability of a UE by providing a PDCCH repetitive transmission method through multiple transmission points (TRPs). Specific methods thereof will be described hereinafter through the embodiments below.

Hereinafter, embodiments of the disclosure will be described in detail in conjunction with the accompanying drawings. The contents of the disclosure may be applied to FDD and TDD systems. As used herein, upper signaling (or upper layer signaling”) is a method for transferring signals from a base station to a UE by using a downlink data channel of a physical layer, or from the UE to the base station by using an uplink data channel of the physical layer, and may also be referred to as “RRC signaling”, “PDCP signaling”, or “MAC control element (MAC CE)”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed, for the sake of descriptive convenience, that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, embodiments of the disclosure will be described in detail in conjunction with the accompanying drawings. Hereinafter, a base station refers to an entity that allocates resources to a terminal, and may be at least one of a gNode B, a gNB, an eNode B, a node B, a base station (BS), a radio access unit, a base station controller, or a node on a network. A terminal may include a user equipment (UE), a mobile station (MS), a cellular phone, a smartphone, a computer, or a multimedia system capable of performing a communication function. In the following description of embodiments of the disclosure, a 5G system will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure. The contents of the disclosure may be applied to FDD and TDD systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the disclosure.

In the following description of the disclosure, upper layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

### [Regarding Scell Deactivation and Scell Dormancy]

A UE may access a primary cell (Pcell) through an initial access, and a base station may additionally configure one or multiple secondary cells (Scells) for the UE. The UE may perform communication through serving cells including the Pcell and Scells configured by the base station.

Methods for reducing power consumed by a UE in a 5G communication system have been defined. Scell deactivation and Scell dormancy correspond to a method for reducing power consumed by a UE by an operation in which a Scell configured for the UE is not used for data transmission/reception.

Scell deactivation may be configured for an activated Scell through an upper layer signal (MAC-CE or RRC). If Scell deactivation is indicated to a Scell, the Scell is deactivated. In a deactivated cell, the UE may transmit no SRS in the cell, may report no CSI for the cell, may transmit no UL-SCH in the cell, may transmit no RACH in the cell, may transmit no PDCCH in the cell, may monitor no PDCCH for the cell, and may transmit no PUCCH in the cell.

In a deactivated Scell, Scell activation may be configured through an upper layer signal (MAC-CE or RRC). If Scell activation is indicated to the Scell, the Scell is activated. In the BWP that is activated first in the activated cell, the UE may perform SRS transmission, CSI reporting, PDCCH monitoring, and PUCCH transmission.

The BWP that is activated first may be configured for the UE by the base station through an upper layer signal (RRC signal). The UE may consider that the BWP corresponding to firstActiveDownlinkBWP-Id is the BWP that is activated first.

Scell activation or Scell deactivation may be transmitted through a MAC-CE. If the UE receives a MAC-CE that indicates Scell activation of Scell deactivation through a PDSCH, the UE may apply the Scell activation or Scell deactivation after a predetermined time since transmission of a HARQ-ACK of the PDSCH. More specifically, if a PUCCH that transmits a HARQ-ACK is transmitted in slot k, the Scell activation or Scell deactivation may be applied in the first slot after slot k+3*Nₛₗₒₜ^{subframe,μ}. Nₛₗₒₜ^{subframe,μ} slot refers to the number of slots included in one subframe when the subcarrier spacing is 15*2^{μ} kHz.

Since the Scell deactivation and Scell activation are transmitted through an upper layer signal (for example, MAC-CE or RRC signal), a latency may thus occur. In addition, since no CSI reporting is performed in the deactivated Scell, data transmission/reception may be possible after CSI configuration and CSI reporting after the base station activates the Scell. In order to solve this, Scell dormancy has been introduced in 5G systems.

The UE may configure a dormant BWP for the Scell through an upper layer signal. The UE may receive no configuration for PDCCH monitoring regarding the dormant BWP from the base station. That is, the UE may not monitor the PDCCH in the dormant BWP. If multiple BWPs are configured for the Scell, the UE may activate one of the multiple BWPs. The activated BWP may be a dormant BWP. If the dormant BWP is activated for the Scell, the Scell may be referred to as being in a dormant state. If the dormant BWP is activated for the Scell (if the dormant BWP is indicated as an active BWP), the UE may monitor no PDCCH in the dormant BWP, may monitor no PDCCH for the dormant BWP, may receive no DL-SCH in the dormant BWP, may report no CSI in the dormant BWP, may transmit no SRS in the dormant BWP, may transmit no UL-SCH in the dormant BWP, may transmit no RACH in the dormant BWP, and may transmit no PUCCH in the dormant BWP. However, the UE may perform CSI reporting, except for aperiodic CSI reporting for the dormant BWP.

The UE may have a Scell dormancy indicator indicated through DCI. According to the Scell dormancy indicator, dormancy or non-dormancy (activation) of the Scell may be indicated. If dormancy of the Scell is indicated, the dormant BWP of the cell may be activated. If non-dormancy of the Scell is indicated, a specific BWP of the cell may be activated. The specific BWP may be a BWP configured by the base station. The specific BWP may be a BWP corresponding to firstOutsideActiveTimeBWP-Id or firstWithinActiveTimeBWP-Id. The BWP corresponding to firstOutsideActiveTimeBWP-Id is activated when DCI that indicates Scell dormancy is received outside an active time, and the BWP corresponding to firstWIthinActiveTimeBWP-Id is activated when DCI that indicates Scell dormancy is received within the active time.

### [Regarding Type-1 HARQ-ACK Codebook]

In the situation described below, the PUCCH that may be used by a UE to transmit HARQ-ACK information in one time unit (for example, slot, sub-slot, mini-slot) is limited to one. The time unit is a slot in the following description, unless specifically mentioned otherwise, but this may be expanded to a sub-slot, a mini-slot, and the like.

The UE may have a Type-1 HARQ-ACK codebook (semi-static HARQ-ACK codebook) configured therefor by the base station. The configuration may be made through an upper layer signal (for example, RRC signal). The upper layer signal for generating a semi-static HARQ-ACK codebook may include at least one of the following:
a) on a set of slot timing values K1 associated with the active UL BWP
a) If the UE is configured to monitor PDCCH for DCI format 1_0 and is not configured to monitor PDCCH for DCI format 1_1 on serving cell c, K1 is provided by the slot timing values {1, 2, 3, 4, 5, 6, 7, 8} for DCI format 1_0
b) If the UE is configured to monitor PDCCH for DCI format 1_1 for serving cell c, K1 is 1 provided by dl-DataToUL-ACK for DCI format 1_1
b) on a set of row indexes R of a table that is provided either by a first set of row indexes of a table that is provided by pdsch-TimeDomainAllocationList in pdsch-ConfigCommon or by Default PDSCH time domain resource allocation A [6, TS 38.214], or by the union of the first set of row indexes and a second set of row indexes, if provided by pdsch-TimeDomainAllocationList in pdsch-Config, associated with the active DL BWP and defining respective sets of slot offsets K0, start and length indicators SLIV, and PDSCH mapping types for PDSCH reception as described in [6, TS 38.214]
c) on the ratio 2^{μDL-μUL} between the downlink SCS configuration μ_{DL} and the uplink SCS configuration μ_{UL} provided by subcarrierSpacing in BWP-Downlink and BWP-Uplink for the active DL BWP and the active UL BWP, respectively
d) if provided, on tdd-UL-DL-ConfigurationCommon and tdd-UL-DL-ConfigurationDedicated.

Above parameters, DataToUL-ACK, pdsch-TimeDomainAllocationList, pdsch-ConfigCommon, pdsch-TimeDomainAllocationList, pdsch-Config, subcarrierSpacing, tdd-UL-DL-ConfigurationCommon, and/or tdd-UL-DL-ConfigurationDedicated may be configured from an upper layer signal.

In addition, the UE may determine the number of HARQ-ACK bits for one PDSCH, based on parameters maxNrofCodeWordsScheduledByDCI and harq-ACK-SpatialBundlingPUCCH. Parameter maxNrofCodeWordsScheduledByDCI is used to configure the maximum number of transport blocks which the PDSCH may include, and the value thereof may be one of 1 or 2. If the value of maxNrofCodeWordsScheduledByDCI is 2, the PDSCH may include a maximum of two transport blocks, and the UE may thus include two HARQ-ACK bits for the PDSCH in the semi-static codebook. Parameter harq-ACK-SpatialBundlingPUCCH may be used to configure spatial bundling of two HARQ-ACK bits of the PDSCH. As used herein, spatial bundling means that a one-bit ACK is generated if the two HARQ-ACK bits are all ACKs, and a one-bit NACK is generated otherwise.

The UE may receive a DCI format from the base station. The UE may transmit a PDSCH scheduled by the DCI format or SPS PDSCH release or Scell dormancy indication's HARQ-ACK information in a slot indicated by the value of a PDSCH-to-HARQ_feedback timing indicator field in the DCI format. The UE may generate a HARQ-ACK codebook according to a predetermined rule, based on the HARQ-ACK information, and may transmit the same to one PUCH in the slot.

More detailed rules for generating a semi-static HARQ-ACK codebook are as follows:

The UE report a NACK as the HARQ-ACK information bit value in the HARQ-ACK codebook by using a slot not indicated by the PDSCH-to-HARQ_feedback timing indicator field in the DCI format.

If the UE reports only HARQ-ACK information regarding one PDSCH reception or one SPS PDSCH release in all M_{A,c} cases for candidate PDSCH reception, and if the report is scheduled by DCI format 1_0 including information having a counter DAI field that indicates 1 in the Pcell, the UE then determines one HARQ-ACK codebook regarding the corresponding SPS PDSCH release or corresponding PDSCH reception.

Otherwise, the HARQ-ACK codebook determination method described below in detail is followed.

In the disclosure, the PDSCH-to-HARQ_feedback timing indicator will be referred to as a K1 value for convenience of description. The UE may have multiple K1 values configured therefor, and the multiple K1 values are referred to as a K1 set as a whole.

A set of PDSCH reception candidate occasions in serving cell c is referred to as M_{A,c}, and a method for obtaining M_{A,c} will hereinafter be described.

In case that a PDSCH scheduled by a DCI format is received in one slot, this may include a case in which pdsch-AggregationFactor is not configured by the upper layer.

When a PUCCH or PUSCH is transmitted to transfer a Type-1 HARQ-ACK codebook in slot n, a pseudo-code to this end is as follows:

### [Pseudo-Code]

Preparation step: set R is a set of scheduling information (information regarding a slot to which a PDSCH is mapped (hereinafter, referred to as K0 value) and/or starting symbol and length information (hereinafter, referred to as starting and length value (SLIV)) configured in a time domain resource assignment (TDRA) table. If the UE monitors one or more DCI formats, and if the DCI formats user different TDRA tables, then the set R is generated based on the union of rows of all TDRA tables.
Step 0: initialize M_{A,c} to a null set. Initialize k to 0. Initialize j to 0.
Step 1: select the kth largest K1 value from the configured K1 set. (For example, if k=0, select the largest K1 value from the K1 set, and if k=1, select the second largest K1 value from the K1 set.) The K1 value is referred to as K1, k.
Step 2: if the symbol corresponding to the SLIV belonging to each row of set R in the slot (slot n-K1, k) corresponding to the K1, k value overlaps the symbol configured for the uplink by the upper layer, the row may be excluded from set R.
Step 3-1 (in case that the UE has UE capability such that a maximum of one unicast PDSCH can be solely received in one slot), unless the determined set R is a null set, j is added as a new PDSCH reception candidate occasion to set M_{A,c}. If one of PDSCH candidates of set R is received, the UE may position the one PDSCH's HARQ-ACK in the new PDSCH reception candidate occasion j. j is increased by 1.
Step 3-2 (in case that the UE has UE capability such that more than one unicast PDSCHs can be received in one slot), for the sake of the SLIV which ends first in the determined set R and SLIVs which temporally overlaps that SLIV, j is added as a new PDSCH reception candidate occasion to set M_{A,c}. If one of PDSCH candidates having the SLIV is received, the UE may position the one PDSCH's HARQ-ACK in the new PDSCH reception candidate occasion j. j is increased by 1. The SLIVs are excluded from set R. Step 3-2 is repeated until set R is a null set.
Step 4: k is increased by 1. If k is smaller than the cardinality of the K1 set, the process is restarted from step 2. If k is equal to or larger than the cardinality of the K1 set, the pseudo-code is ended.

### [Pseudo-Code]

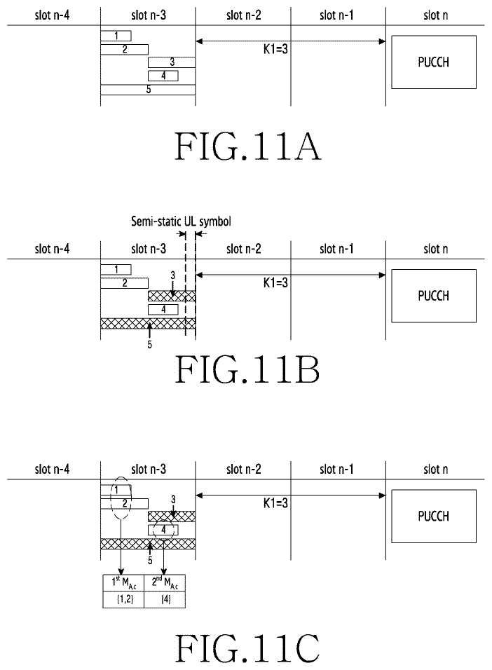

FIG. 11A, FIG. 11B, and FIG. 11C illustrate a Type-1 HARQ-ACK codebook.

The above-described pseudo-code will be described with reference to FIG. 11A, FIG. 11B, and FIG. 11C. A PUCCH including HARQ-ACK information is transmitted in slot n. The HARQ-ACK information may be generated as a Type-1 HARQ-ACK codebook.

It will be assumed that the UE has a K1 value configured as K1=3. In addition, the TDRA table of the DCI format monitored by the UE may include five rows as in Table 16. For reference, K0 values and SLIV values or PDSCH mapping type values may be configured in respective rows, but PDSCH mapping type values are omitted for convenience of description.

TABLE 16

| Index | K0 | SLIV (S, L) | |
|---|---|---|---|
| 1 | 0 | SLIV1 | (0, 4) |
| 2 | 0 | SLIV2 | (0, 7) |
| 3 | 0 | SLIV3 | (7, 7) |
| 4 | 0 | SLIV4 | (7, 4) |
| 5 | 0 | SLIV5 | (0, 14) |

The UE may include respective rows of the TDRA table in set R according to the preparation step. FIG. 11A illustrates SLIVs according to respective rows. The UE may determine a PDSCH reception candidate occasion M_{A,c}, based on the K1 value and the set R. With reference to FIG. 11A, FIG. 11B, and FIG. 11C, pseudo code 1 may be interpreted as follows. In the following description, the UE has UE capability such that more than one unicast PDSCHs can be received in one slot.
Step 0: M_{A,c} is initialized to a null set, k is initialized to 0, and j is initialized to 0.
Step 1: the (k=0)th largest K1 value is selected from the configured K1 set. The K1 value is K1, 0=3.
Step 2: if the symbol corresponding to the SLIV belonging to each row of set R in the slot n-K1, 0=n-3 overlaps the symbol configured for the uplink by the upper layer, the row may be excluded from set R. Referring to FIG. 11B, if some symbols in slot n-3 are semi-static UL symbols configured by the upper layer, the row including SLIVs overlapping the symbols may be excluded from set R. Referring to FIG. 11B, the last two symbols in slot n-3 may be semi-static UL symbols, and SLIV (7,7) in row 3 and SLIV (0,14) in row 5 overlap the semi-static UL symbols and thus may be excluded from set R. Set R may include rows 1, 2, and 4.
Step 3-2 (in case that the UE has UE capability such that more than one unicast PDSCHs can be received in one slot):
For the sake of the SLIV which ends first in the determined set R and SLIVs which temporally overlaps that SLIV, j=0 is added as a new PDSCH reception candidate occasion to set M_{A,c}. The SLIV which ends first is SLIV (0,4) in row 1, and the SLIV which overlaps that SLIV is SLIV (0,7) in row 2. Therefore, j=0 is added to M_{A,c}, and if the UE receives a PDSCH scheduled by SLIV (0,4) in row 1 or SLIV (0,7) in row 2, the PDSCH's HARQ-ACK may be included in a position corresponding to the first (j=0) M_{A,c} in the type-1 HARQ-ACK codebook. j is increased by 1 and becomes j=1. The SLIVs in rows 1 and 2 are excluded from set R, and thus R={4}. Step 3-2 is repeated because set R is not a null set.
For the sake of the SLIV which ends first in the determined set R and SLIVs which temporally overlaps that SLIV, j=1 is added as a new PDSCH reception candidate occasion to set M_{A,c}. The SLIV which ends first is SLIV (7,4) in row 4, and no SLIV overlaps that SLIV. Therefore, j=1 is added to M_{A,c}, and if the UE receives a PDSCH scheduled by SLIV (7,4) in row 4, the PDSCH's HARQ-ACK may be included in a position corresponding to the second (j=1) M_{A,c} in the type-1 HARQ-ACK codebook. j is increased by 1 and becomes j=1. The SLIVs in row 4 are excluded from set R, and R thus becomes a null set. Therefore, step 3-2 may be ended.
Step 4: k is increased by 1 and thus becomes k=1. Since k=1 is equal to the cardinality (which is 1) of the K1 set, the pseudo-code is ended.

Therefore, with reference to FIG. 11A, FIG. 11B, and FIG. 11C, the UE may determine two PDSCH reception candidate occasions j=0, j=1 M_{A,c}. The size of the Type-1 HARQ-ACK codebook may be determined according to the number of PDSCH reception candidate occasions. The actual number of bits per PDSCH reception candidate occasion may be determined according to parameters such as the number of transport blocks included in each PDSCH (maxNrofCodeWordsScheduledByDCI), the number of code block groups (CBGs) included in each PDSCH, and/or spatial bundling configuration (harq-ACK-SpatialBundlingPUCCH).

### [Regarding Type-3 HARQ-ACK Codebook]

According to the Type-3 HARQ-ACK codebook (or one-shot codebook), all HARQ-ACK information regarding all serving cells configured for the UE, HARQ process IDs, the number of TBs with regard to each HARQ process, and/or the number of code block groups (CBGs) with regard to each TB, is reported. As an example, in case that the UE has two serving cells, 16 HARQ processes with regard to each serving cell, two TBs with regard to each HARQ process, and two CBGs with regard to each TB, the UE reports a total of 128 (=2*16*2*2) HARQ-ACK information bits.

The Type-3 HARQ-ACK codebook may enumerate HARQ-ACK information bits according to a series of orders. The series of orders is as follows:
HARQ-ACK information bits may be sorted in the ascending order of the serving cell index.
In the same serving cell, HARQ-ACK information bits may be sorted in the ascending order of the HARQ process ID.
In case that the same HARQ process includes multiple TBs (e.g., in the case of 2-TB transmission), HARQ-ACK information bits of the first TB may be sorted so as to precede HARQ-ACK information bits of the second TB.
In case that the same TB includes multiple CBGs (that is, in the case of CBG-based PDSCH transmission), HARQ-ACK information bits may be sorted in the ascending order of the CBG index.

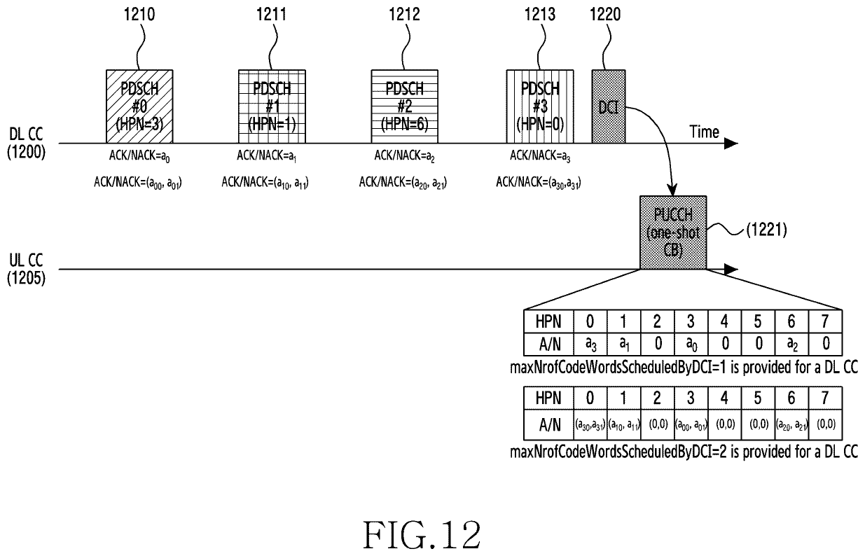

FIG. 12 illustrates a method for transmitting a Type-3 HARQ-ACK according to an embodiment of the disclosure.

Referring to FIG. 12, the UE may have one downlink serving cell (DL CC) 1200 and one uplink serving cell (UL CC) 1205 configured therefor. The uplink serving cell is used to transmit a PUCCH 1221. The number of HARQ processes configured for the UE with regard to the downlink serving cell 1200 is 8 (i.e., n8), and one PDSCH may be configured to include only one TB (the value of maxNrofCodeWordsScheduledByDCI is 1). No CBG-based transmission may be configured. The Type-3 HARQ-ACK codebook may be configured according to all serving cells and HARQ process IDs, the number of TBs with regard to each HARQ process. Therefore, since the UE has eight HARQ process IDs configured for one serving cell and has one TB configured for each HARQ process, the Type-3 HARQ-ACK codebook may include eight bits of HARQ-ACK information.

The UE may sort eight bits of the type-3 HARQ-ACK codebook according to the ascending order of the HARQ process ID in the downlink serving cell 1200. Since the UE has eight HARQ process IDs configured for the downlink serving cell 1200,
One-bit HARQ-ACK information of HARQ process ID 0 may be positioned first in the Type-3 HARQ-ACK codebook,
One-bit HARQ-ACK information of HARQ process ID 1 may be positioned second in the Type-3 HARQ-ACK codebook,
One-bit HARQ-ACK information of HARQ process ID 2 may be positioned third in the Type-3 HARQ-ACK codebook,
One-bit HARQ-ACK information of HARQ process ID 3 may be positioned fourth in the Type-3 HARQ-ACK codebook,
One-bit HARQ-ACK information of HARQ process ID 4 may be positioned fifth in the Type-3 HARQ-ACK codebook,
One-bit HARQ-ACK information of HARQ process ID 5 may be positioned sixth in the Type-3 HARQ-ACK codebook,
One-bit HARQ-ACK information of HARQ process ID 6 may be positioned seventh in the Type-3 HARQ-ACK codebook, and
One-bit HARQ-ACK information of HARQ process ID 7 may be positioned eighth in the Type-3 HARQ-ACK codebook.

Referring to FIG. 12, the UE may receive four PDSCHs in the downlink serving cell 1200. In the time order, the UE may receive PDSCH #0 1210, PDSCH #1 1211, PDSCH #2 1212, and PDSCH #3 1213. The HARQ process ID corresponding to each PDSCH may be indicated by the HARQ process number field of DCI. PDSCH #0 has been indicated by HARQ process ID 3, and one-bit HARQ-ACK information of the PDSCH #0 is referred to as a0. PDSCH #1 has been indicated by HARQ process ID 1, and one-bit HARQ-ACK information of the PDSCH #1 is referred to as a1. PDSCH #2 has been indicated by HARQ process ID 6, and one-bit HARQ-ACK information of the PDSCH #2 is referred to as a2. PDSCH #3 has been indicated by HARQ process ID 0, and one-bit HARQ-ACK information of the PDSCH #3 is referred to as a3. The UE may include a0, a1, a2, and a3 (the HARQ-ACK information) in the Type-3 HARQ-ACK codebook according to the ascending order of the HARQ process ID. That is, since the HARQ process ID of PDSCH #0 is 3, a0 which is the HARQ-ACK of the PDSCH #0 may be included in the fourth bit of the Type-3 HARQ-ACK codebook. Since the HARQ process ID of PDSCH #1 is 1, a1 which is the HARQ-ACK of the PDSCH #1 may be included in the second bit of the Type-3 HARQ-ACK codebook. Since the HARQ process ID of PDSCH #2 is 6, a2 which is the HARQ-ACK of the PDSCH #2 may be included in the seventh bit of the Type-3 HARQ-ACK codebook. Finally, since the HARQ process ID of PDSCH #3 is 0, a3 which is the HARQ-ACK of the PDSCH #3 may be included in the first bit of the Type-3 HARQ-ACK codebook. For reference, with regard to a HARQ process ID which the UE has failed to receive in the Type-3 HARQ-ACK codebook, or a HARQ process ID which has already been fed back to the base station, NACK (or 0) may be included.

The UE may receive DCI 1220 that indicates transmission of the Type-3 HARQ-ACK codebook in the downlink serving cell 1200. The UE may have a PUCCH 1221 resource for transmitting the Type-3 HARQ-ACK codebook indicated by the DCI. The UE may transmit eight bits of the Type-3 HARQ-ACK codebook by using the PUCCH resource.

Referring to FIG. 12, the UE may have one downlink serving cell (DL CC) 1200 and one uplink serving cell (UL CC) 1205 configured therefor. The uplink serving cell is used to transmit a PUCCH 1221. The number of HARQ processes configured for the UE with regard to the downlink serving cell 1200 is 8 (i.e., n8), and one PDSCH may be configured to include two TBs (the value of (maxNrofCodeWordsScheduledByDCI is 2). No CBG-based transmission may be configured. The Type-3 HARQ-ACK codebook may be generated according to all serving cells and HARQ process IDs, the number of TBs with regard to each HARQ process. Therefore, since the UE has eight HARQ process IDs configured for one serving cell and has two TBs configured for each HARQ process, the Type-3 HARQ-ACK codebook may include 8*2=16 bits of HARQ-ACK information.

The UE may sort 16 bits of the type-3 HARQ-ACK codebook according to the ascending order of the HARQ process ID in the downlink serving cell 1200. Since the UE has eight HARQ process IDs configured for the downlink serving cell 1200,
Two-bit HARQ-ACK information of HARQ process ID 0 may be positioned first in the Type-3 HARQ-ACK codebook,
Two-bit HARQ-ACK information of HARQ process ID 1 may be positioned second in the Type-3 HARQ-ACK codebook,
Two-bit HARQ-ACK information of HARQ process ID 2 may be positioned third in the Type-3 HARQ-ACK codebook,
Two-bit HARQ-ACK information of HARQ process ID 3 may be positioned fourth in the Type-3 HARQ-ACK codebook,
Two-bit HARQ-ACK information of HARQ process ID 4 may be positioned fifth in the Type-3 HARQ-ACK codebook,
Two-bit HARQ-ACK information of HARQ process ID 5 may be positioned sixth in the Type-3 HARQ-ACK codebook,
Two-bit HARQ-ACK information of HARQ process ID 6 may be positioned seventh in the Type-3 HARQ-ACK codebook, and
Two-bit HARQ-ACK information of HARQ process ID 7 may be positioned last in the Type-3 HARQ-ACK codebook.

Referring to FIG. 12, the UE may receive four PDSCHs in the downlink serving cell 1200. In the time order, the UE may receive PDSCH #0 1210, PDSCH #1 1211, PDSCH #2 1212, and PDSCH #3 1213. The HARQ process ID corresponding to each PDSCH may be indicated by the HARQ process number field of DCI. PDSCH #0 has been indicated by HARQ process ID 3, and two-bit HARQ-ACK information of the PDSCH #0 is referred to as (a₀₀, a₀₁). PDSCH #1 has been indicated by HARQ process ID 1, and two-bit HARQ-ACK information of the PDSCH #1 is referred to as (a₁₀, a₁₁). PDSCH #2 has been indicated by HARQ process ID 6, and two-bit HARQ-ACK information of the PDSCH #2 is referred to as (a₂₀, a₂₁). PDSCH #3 has been indicated by HARQ process ID 0, and two-bit HARQ-ACK information of the PDSCH #3 is referred to as (a₃₀, a₃₁). The UE may include (a₀₀, a₀₁), (a₁₀, a₁₁), (a₂₀, a₂₁), and (a₃₀, a₃₁) (the HARQ-ACK information) in the Type-3 HARQ-ACK codebook according to the ascending order of the HARQ process ID. That is, since the HARQ process ID of PDSCH #0 is 3, (a₀₀, a₀₁) which is the HARQ-ACK of the PDSCH #0 may be included in the fourth position of the Type-3 HARQ-ACK codebook. Since the HARQ process ID of PDSCH #1 is 1, (a₁₀, a₁₁) which is the HARQ-ACK of the PDSCH #1 may be included in the second position of the Type-3 HARQ-ACK codebook. Since the HARQ process ID of PDSCH #2 is 6, (a₂₀, a₂₁) which is the HARQ-ACK of the PDSCH #2 may be included in the seventh position of the Type-3 HARQ-ACK codebook. Finally, since the HARQ process ID of PDSCH #3 is 0, (a₃₀, a₃₁) which is the HARQ-ACK of the PDSCH #3 may be included in the first position of the Type-3 HARQ-ACK codebook. For reference, with regard to a HARQ process ID which the UE has failed to receive in the Type-3 HARQ-ACK codebook, or a HARQ process ID which has already been fed back to the base station, (NACK, NACK) (or (0,0)) may be included.

The UE may receive DCI 1220 that indicates transmission of the Type-3 HARQ-ACK codebook in the downlink serving cell 1200. The UE may have a PUCCH 1221 resource for transmitting the Type-3 HARQ-ACK codebook indicated by the DCI. The UE may transmit 16 bits of the Type-3 HARQ-ACK codebook by using the PUCCH resource.

According to a separate configuration regarding the Type-3 HARQ-ACK codebook, it may also be possible to report a NDI value recently received by the UE together with regard to every serving cell and HARQ process in addition to HARQ-ACK information. Through the NDI value, the base station may determine whether a PDSCH received with regard to each HARQ process of the UE is deemed to be initial transmission or retransmission.

In case that no NDI value report is separately configured, and in case that HARQ-ACK information has already been reported with regard to a specific HARQ process before the base station receives DCI that requests a Type-3 HARQ-ACK codebook, the UE may map a NACK with regard to the corresponding HARQ process. In case that no HARQ-ACK information has already been reported with regard to a specific HARQ process before the base station receives DCI that requests a Type-3 HARQ-ACK codebook, HARQ-ACK information bits may be mapped to the corresponding HARQ process with regard to already received PDSCH.

The number of serving cells, the number of HARQ processes, the number of TBs, and the number of CBGs may be configured respectively. If there is no separate configuration regarding each, the UE may consider that the number of serving cells is 1, the number of HARQ processes is 8, the number of TBs is 1, and the number of CBGs is 1. In addition, the number of HARQ processes may differ with regard to each serving cell. In addition, the number of TBs may differ with regard to each serving cell or each BWP in the serving cell. In addition, the number of CBGs may differ with regard to each serving cell.

As one of the reasons the Type-3 HARQ-ACK codebook is necessary, there may be a case in which the UE fails to receive a PUCCH or PUSCH including HARQ-ACK information regarding a PDSCH due to a channel access failure, overlapping with another channel having a high priority, or the like. In this case, the base station has no need to reschedule a separate PDSCH, and it is thus reasonable for the base station to report corresponding HARQ-ACK information only. Therefore, it may be possible for the UE to schedule Type-3 HARQ-ACK codebook transmission and a PUCCH resource to transmit the codebook, through an upper-level signal or L1 signal (for example, a specific field in DCI) from the base station.

The UE may include an indicator in the DCI format to indicate the Type-3 HARQ-ACK codebook transmission. The indicator may indicate 0 or 1.

In case that the UE receives a DCI format including 1 as the value of a field for requesting Type-3 HARQ-ACK codebook transmission, the UE may determine a PUCCH or PUSCH resource for transmitting the Type-3 HARQ-ACK codebook in a specific slot indicated by the DCI format. The UE may also multiplex only the Type-3 HARQ-ACK codebook in the PUCCH or PUSCH of the corresponding slot. In addition, the UE may not schedule the PDSCH of the DCI format. That is, fields for PDSCH transmission in the DCI format may not be used to schedule a PDSCH. Furthermore, the fields not used to schedule the PDSCH may be used for other purposes.

The Type-3 HARQ-ACK codebook must include HARQ-ACK information of all serving cells and all HARQ processes, based on information configured for the UE. Therefore, HARQ-ACK information bits regarding a PDSCH of a HARQ process which is not actually used must be included in the codebook as a NACK. This results in the shortcoming of a large size of the Type-3 HARQ-ACK codebook. Therefore, as the uplink control information bit size increases, there is a possibility that the uplink transmission coverage or transmission reliability will decrease. There is a need for a HARQ-ACK codebook having a smaller size than the Type-3 HARQ-ACK codebook. Such a codebook may be referred to as an enhanced Type-3 HARQ-ACK codebook. As an example, the enhanced Type-3 HARQ-ACK codebook may be configured as follows:
Type A: a subset of the entire set of (configured) serving cells
Type B: a subset of the entire set of (configured) HARQ process IDs
Type C: a subset of the entire set of (configured) TB indices
Type D: a subset of the entire set of (configured) CBG indices
Type E: a combination of at least two types among the above types A to D

The enhanced Type-3 HARQ-ACK codebook may have features of at least one of types A to E, and may be configured by one set or multiple sets. The subset may include the entire set. As an example, type A may be the entire set of (configured) serving cells. Multiple sets may refer to a combination of at least two of types A to E. As an example, the multiple sets may refer to a combination of types A and B. Alternatively, as an example, the multiple sets may refer to a combination of type A and subsets of types B to E.

The UE may have the type of the enhanced Type-3 HARQ-ACK codebook indicated by an upper layer signal or an L1 signal or a combination thereof. As an example, as in [Table 17], a set configuration for HARQ-ACK information bits to be reported as each enhanced Type-3 HARQ-ACK codebook may be indicated by an upper layer signal, and one value thereof may be indicated by an L1 signal. As in [Table 17], the enhanced Type-3 HARQ-ACK codebook may be configured with regard to each index by an upper layer signal. For convenience, a table such as [Table 17] may be referred to as an enhanced Type-3 HARQ-ACK codebook type table.

A Type-3 HARQ-ACK codebook may be used to report all HARQ-ACK information bits with regard to a specific index (e.g., index 3 in [Table 17]) of the enhanced Type-3 HARQ-ACK codebook type table. The Type-3 HARQ-ACK codebook may be indicated by a separate upper-level signal. Alternatively, if there is no upper-level signal, it may be determined that the Type-3 HARQ-ACK codebook is used as a default value (for example, ACK or NACK state with regard to all HARQ process IDs).

TABLE 17
Enhanced Type-3 HARQ-ACK codebook type table

| Index | Enhanced Type-3 HARQ-ACK codebook configuration |
|---|---|
| 1 | Serving cell I, HARQ process ID(0~7) |
| 2 | Serving cell I, HARQ process ID(8~11) |
| 3 | Type-3 HARQ-ACK codebook |
| . . . | . . . |

For example, in case that the UE receives a value indicated by index 1, the UE may report an enhanced Type-3 HARQ-ACK codebook including a total of eight bits of HARQ-ACK information with regard to serving cell i, HARQ process (0-7), TB 1 according to [Table 17]. In case that the UE receives a value indicated by index 2, the UE may report a total of four HARQ-ACK information bits with regard to serving cell i, HARQ process (8-11), TB 1 according to [Table 17]. In case that the UE receives a value indicated by index 3, the UE may calculate the total number of HARQ-ACK bits in consideration of the serving cell set, the total number of HARQ processes with regard to each serving cell i, the number of TBs with regard to each HARQ process, and the number of CBGs with regard to each TB according to [Table 17]. [Table 17] is only an example, the total number of indices may be larger or smaller than this, and the range of HARQ process values indicated by respective indices and/or information included in the enhanced Type-3 HARQ-ACK codebook may differ. In addition, [Table 17] may be information indicted by an upper layer signal (e.g., RRC), and a specific index may be notified of through DCI. Selection of a specific index in [Table 17] may be indicated by at least one or a combination of a HARQ process ID in a DCI field, MCS, NDI, RV, frequency resource allocation information, and time resource allocation information. For example, the size of a DCI field which indicates a specific index in [Table 17] may be determined as ┌log2(Nₜₒₜₐₗ^{index})┐. In this regard, Nₜₒₜₐₗ^{index} refers to the total number of indices in [Table 17] configured by an upper-level signal.

The UE may have enhanced Type-3 HARQ-ACK codebook transmission configured therefor. For example, if index 0 is indicated by DCI for triggering enhanced Type-3 HARQ-ACK codebook transmission, the enhanced Type-3 HARQ-ACK codebook to be transmitted by the UE may include only HARQ-ACK information regarding HARQ processes of {0, 1, 2, 3} among eight HARQ processes, and may include no HARQ-ACK information regarding HARQ processes of {4,5,6,7}. For example, if index 1 is indicated by DCI for triggering enhanced Type-3 HARQ-ACK codebook transmission, the enhanced Type-3 HARQ-ACK codebook to be transmitted by the UE may include only HARQ-ACK information regarding HARQ processes of {4,5,6,7} among eight HARQ processes, and may include no HARQ-ACK information regarding HARQ processes of {0, 1, 2, 3}. An index other than indices 0 and 1 may be further indicated, and if the index is indicated, an enhanced Type-3 HARQ-ACK codebook including only HARQ-ACK information regarding the HARQ process corresponding to the index may be transmitted.

In one embodiment methods for acquiring parameters for HARQ-ACK codebook generation may be provided.

When the UE generates a HARQ-ACK codebook, the UE may include HARQ-ACK information of PDSCHs received in cells included in a PUCCH cell group in the HARQ-ACK codebook. If at least one secondary cell among cells included in the PUCCH cell group is deactivated, or if the secondary cell is in a dormant state (a dormant BWP is activated), the UE may fail to acquire the value of a parameter for generating HARQ-ACK bits of the secondary cell in the HARQ-ACK codebook. For convenience, the deactivated secondary cell is referred to as the first cell, and secondary cell in a dormant state (a cell having a dormant BWP activated) is referred to as the second cell.

The PUCCH cell group may be a primary PUCCH cell group or secondary PUCCH cell group.

The parameter may include at least one of the following first parameter or second parameter.

The first parameter may be used to configure the maximum number of transport blocks that may be transmitted through a PDSCH. The maximum number of transport blocks is a value configured for each BWP, and may have the name maxNrofCodeWordsScheduledByDCI in an upper layer signal (for example, RRC signal). The value maxNrofCodeWordsScheduledByDCI of may be one of 1 or 2. If the value of maxNrofCodeWordsScheduledByDCI is 1, the PDSCH may include a maximum of one transport block. Therefore, the Type-1 (semi-static) HARQ-ACK codebook may include only HARQ-ACK bits for one transport block per PDSCH. In addition, the Type-3 HARQ-ACK codebook may include only HARQ-ACK bits for one transport block per one HARQ process number. If the value of maxNrofCodeWordsScheduledByDCI is 2, the PDSCH may include a maximum of two transport blocks. Therefore, the Type-1 (semi-static) HARQ-ACK codebook must include HARQ-ACK bits for two transport blocks per PDSCH. In addition, the Type-3 HARQ-ACK codebook may include HARQ-ACK bits for two transports block per one HARQ process number. Since maxNrofCodeWordsScheduledByDCI is configured for a BWP, in the case of the first cell, there is no activated BWP, and the UE thus cannot acquire the maxNrofCodeWordsScheduledByDCI value. In the case of the second cell, no PDSCH is received, and maxNrofCodeWordsScheduledByDCI is not configured and thus cannot be acquired.

The second parameter may be used to configure time domain resource assignment (TDRA) by which a PDSCH may be scheduled. In case that the UE has a PDSCH configured therefor through DCI, the DCI may indicate OFDM symbols occupied by the PDSCH. Information regarding the OFDM symbols may be indicated by the TDRA or TDRA table. More specifically, the UE may have the TDRA table configured by the base station, and each row of the TDRA table may include information regarding the number of OFDM symbols continuous with the index of the starting OFDM symbol in a slot. The UE may have one row of the TDRA table indicated by DCI that schedules a PDSCH, and may acquire information regarding OFDM symbols by which a PDSCH is scheduled. A TDRA table to be used for a BWP or a TDRA table to be used commonly for a cell (BWP-common) may be configured for the UE. The TDRA table to be used for a BWP may be referred to as a BWP-specific TDRA table, and the TDRA table to be used commonly for a cell may be referred to a cell-common TDRA table. In addition, a default TDRA table may be defined so as to be used in case that the BWP-specific TDRA table and the cell-common TDRA table are not configured for the UE. Multiple TDRA tables may be configured for the UE, and each table may be determined according to a DCI format that schedules a PDSCH. Therefore, since there is no configuration regarding the DCI format that schedules a PDSCH in the first or second cell, it may be ambiguous which TDRA table is to be used. That is, in the case of the first cell, no PDSCH is received because there if no activated BWP, and there may thus be no configuration regarding the DCI format with regard to the first cell. In the case of the second cell, no PDSCH is received because the activated BWP is a dormant BWP, and there may thus be no configuration regarding the DCI format with regard to the second cell as well.

One method relates to using configuration of reference BWP.

In a method of the disclosure, a reference BWP may be defined to acquire values of parameters needed by the UE (that is, a first parameter used to configure the maximum number of transport blocks that may be transmitted through a PDSCH and a second parameter used to configure time domain resource assignment (TDRA) by which a PDSCH may be scheduled). Necessary parameter values may be configured for the reference BWP. That is, the base station must configure necessary parameter values for the reference BWP.

The reference BWP may be at least one of the following:

In the case of the first cell (deactivated cell), the reference BWP may be a BWP corresponding to firstActiveDownlinkBWP-Id. BWP corresponding to firstActiveDownlinkBWP-Id may be activated first when the deactivated cell is activated.

In the case of the second cell (the dormant BWP of which is activated), the reference BWP may be a BWP corresponding to firstOutsideActiveTimeBWP-Id or firstWIthinActiveTimeBWP-Id. The BWP corresponding to firstOutsideActiveTimeBWP-Id is activated upon receiving DCI that indicates Scell dormancy outside an active time, and the BWP corresponding to firstWIthinActiveTimeBWP-Id is activated when DCI that indicates Scell dormancy is received within the active time.

For reference, in the case of the first cell, the BWP corresponding to firstActiveDownlinkBWP-Id may be a dormant BWP. In this case, the reference BWP may correspond to firstOutsideActiveTimeBWP-Id or firstWIthinActiveTimeBWP-Id.

For reference, in case that only one of firstOutsideActiveTimeBWP-Id or firstWIthinActiveTimeBWP-Id is configured, the BWP corresponding to the configured value may be the reference BWP. If both firstOutsideActiveTimeBWP-Id and firstWIthinActiveTimeBWP-Id are configured, the BWP corresponding to the value of one of the two may be the reference BWP. The one value may be firstWIthinActiveTimeBWP-Id.

In another method, a default BWP may be configured for the UE. The default BWP may be activated by expiration of bwp-InactivityTimer. The bwp-InactivityTimer may decrease if no signal is received in the BWP, and may expire if the value becomes 0. The default BWP may be used if BWP synchronization between the UE and the base station is not made. The default BWP may be used as the reference BWP.

In another method, the UE may use a BWP having a specific ID as the reference BWP. For example, the BWP having the lowest ID (BWP the BWP ID of which is 0) may be used as the reference BWP.

In another method, the UE may have the ID of the reference BWP configured by the base station. The UE may use the BWP corresponding to the ID as the reference BWP.

Another method relates to excluding HARQ-ACK information of the cell from the HARQ-ACK codebook.

In a method of the disclosure, the UE may exclude HARQ-ACK bits regarding the first or second cell from the HARQ-ACK codebook. More specifically, in case that parameters necessary for the first or second cell (that is, a first parameter used to configure the maximum number of transport blocks that may be transmitted through a PDSCH and a second parameter used to configure time domain resource assignment (TDRA) by which a PDSCH may be scheduled) are not configured for the UE, the UE may assume that the cell has no HARQ-ACK bits to be reported to the base station. Therefore, when the HARQ-ACK codebook is generated, the cell's index may be skipped. That is, the HARQ-ACK codebook may include no HARQ-ACK bits regarding the cell.

Yet another method relates to defining default parameter values.

In a method of the disclosure, in case that the UE fails to acquire parameters necessary for the first or second cell (that is, a first parameter used to configure the maximum number of transport blocks that may be transmitted through a PDSCH and a second parameter used to configure time domain resource assignment (TDRA) by which a PDSCH may be scheduled), the UE may use default values of the parameters. The default values may be at least one of the following:

The default value of the first parameter (maxNrofCodeWordsScheduledByDCI)
may be 1. Or
may be 2. Or
may be 2 if the maximum number of MIMO layers supported by the PDSCH exceeds 4, and may otherwise be 1. The maximum number of MIMO layers supported by the PDSCH may be a value configured for the UE by the base station and may BWP-common (that is, a value applied to all BWPs).

The default value of the second parameter (TDRA table)
may be the default TDRA table given Table 18, Table 19, Table 20, Table 21. The UE may solely use Table 18, among the same, as the default value of the second parameter.

In another method, the default TDRA table may differ depending on the cyclic prefix (CP) type. The UE may use the default TDRA table (Table 18) for a normal CP as the default value. In another method, if the CP type is configured for the first or second cell, the UE may use the default TDRA table (Table 18 or 19) for the CP type as the default value.

In another method, the default TDRA table may differ depending on the multiplexing pattern between the SS/PBCH block and the CORESET. In this case, the UE may always use the default TDRA table (Table 18) as the default value. As another example, if the multiplexing pattern between the SS/PBCH block and the CORESET is configured or defined for the first or second cell, the UE may use the default TDRA table (Table 18 or 20 or 21) as the default value according to the pattern.
If there is a configured cell-common TDRA table, the UE may assume the cell-common TDRA table as the default value.

The cell-common TDRA table may be pdsch-TimeDomainAllocationList included in PDSCH-ConfigCommon IE. The cell-common TDRA table may be a TDRA table that all BWPs configured in the cell may commonly use.
It may be assumed that the union of rows the default TDRA table given in Table 18 (or Table 19, Table 20, Table 21) and rows of the cell-common TDRA table is the default value of the second parameter. For example, in case that the cell-common TDRA table is not configured for the first or second cell, the default TDRA table given in Table 18 may be used as the default value of the second parameter. In case that the cell-common TDRA table is configured for the first or second cell, the union of rows the default TDRA table given in Table 18 (or Table 19, Table 20, Table 21) and rows of the cell-common TDRA table may be used as the default value of the second parameter.

TABLE 18
Default PDSCH time domain resource allocation A for normal CP

| | | PDSCH | | | |
|---|---|---|---|---|---|
| | dmrs-TypeA- | mapping | | | |
| Row index | Position | type | K₀ | S | L |
| 1 | 2 | Type A | 0 | 2 | 12 |
| | 3 | Type A | 0 | 3 | 11 |
| 2 | 2 | Type A | 0 | 2 | 10 |
| | 3 | Type A | 0 | 3 | 9 |
| 3 | 2 | Type A | 0 | 2 | 9 |
| | 3 | Type A | 0 | 3 | 8 |
| 4 | 2 | Type A | 0 | 2 | 7 |
| | 3 | Type A | 0 | 3 | 6 |
| 5 | 2 | Type A | 0 | 2 | 5 |
| | 3 | Type A | 0 | 3 | 4 |
| 6 | 2 | Type B | 0 | 9 | 4 |
| | 3 | Type B | 0 | 10 | 4 |
| 7 | 2 | Type B | 0 | 4 | 4 |
| | 3 | Type B | 0 | 6 | 4 |
| 8 | 2, 3 | Type B | 0 | 5 | 7 |
| 9 | 2, 3 | Type B | 0 | 5 | 2 |
| 10 | 2, 3 | Type B | 0 | 9 | 2 |
| 11 | 2, 3 | Type B | 0 | 12 | 2 |
| 12 | 2, 3 | Type A | 0 | 1 | 13 |
| 13 | 2, 3 | Type A | 0 | 1 | 6 |
| 14 | 2, 3 | Type A | 0 | 2 | 4 |
| 15 | 2, 3 | Type B | 0 | 4 | 7 |
| 16 | 2, 3 | Type B | 0 | 8 | 4 |

TABLE 19
Default PDSCH time domain resource allocation A for extended CP

| | | PDSCH | | | |
|---|---|---|---|---|---|
| | dmrs-TypeA- | mapping | | | |
| Row index | Position | type | K₀ | S | L |
| 1 | 2 | Type A | 0 | 2 | 6 |
| | 3 | Type A | 0 | 3 | 5 |
| 2 | 2 | Type A | 0 | 2 | 10 |
| | 3 | Type A | 0 | 3 | 9 |
| 3 | 2 | Type A | 0 | 2 | 9 |
| | 3 | Type A | 0 | 3 | 8 |
| 4 | 2 | Type A | 0 | 2 | 7 |
| | 3 | Type A | 0 | 3 | 6 |
| 5 | 2 | Type A | 0 | 2 | 5 |
| | 3 | Type A | 0 | 3 | 4 |
| 6 | 2 | Type B | 0 | 6 | 4 |
| | 3 | Type B | 0 | 8 | 2 |
| 7 | 2 | Type B | 0 | 4 | 4 |
| | 3 | Type B | 0 | 6 | 4 |
| 8 | 2, 3 | Type B | 0 | 5 | 6 |
| 9 | 2, 3 | Type B | 0 | 5 | 2 |
| 10 | 2, 3 | Type B | 0 | 9 | 2 |
| 11 | 2, 3 | Type B | 0 | 10 | 2 |
| 12 | 2, 3 | Type A | 0 | 1 | 11 |
| 13 | 2, 3 | Type A | 0 | 1 | 6 |
| 14 | 2, 3 | Type A | 0 | 2 | 4 |
| 15 | 2, 3 | Type B | 0 | 4 | 6 |
| 16 | 2, 3 | Type B | 0 | 8 | 4 |

TABLE 20
Default PDSCH time domain resource allocation B

| | | PDSCH | | | |
|---|---|---|---|---|---|
| | dmrs-TypeA- | mapping | | | |
| Row index | Position | type | K₀ | S | L |
| 1 | 2, 3 | Type B | 0 | 2 | 2 |
| 2 | 2, 3 | Type B | 0 | 4 | 2 |
| 3 | 2, 3 | Type B | 0 | 6 | 2 |
| 4 | 2, 3 | Type B | 0 | 8 | 2 |
| 5 | 2, 3 | Type B | 0 | 10 | 2 |
| 6 | 2, 3 | Type B | 1 | 2 | 2 |
| 7 | 2, 3 | Type B | 1 | 4 | 2 |
| 8 | 2, 3 | Type B | 0 | 2 | 4 |
| 9 | 2, 3 | Type B | 0 | 4 | 4 |
| 10 | 2, 3 | Type B | 0 | 6 | 4 |
| 11 | 2, 3 | Type B | 0 | 8 | 4 |
| 12 (Note 1) | 2, 3 | Type B | 0 | 10 | 4 |
| 13 (Note 1) | 2, 3 | Type B | 0 | 2 | 7 |
| 14 (Note 1) | 2 | Type A | 0 | 2 | 12 |
| | 3 | Type A | 0 | 3 | 11 |
| 15 | 2, 3 | Type B | 1 | 2 | 4 |

| | |
|---|---|
| 16 | Reserved |

Note 1:
If the PDSCH was scheduled with SI-RNTI in PDCCH Type0 common search space, the UE may assume that this PDSCH resource allocation is not applied

TABLE 21
Default PDSCH time domain resource allocation C

| | | PDSCH | | | |
|---|---|---|---|---|---|
| | dmrs-TypeA- | mapping | | | |
| Row index | Position | type | K₀ | S | L |
| 1 (Note 1) | 2, 3 | Type B | 0 | 2 | 2 |
| 2 | 2, 3 | Type B | 0 | 4 | 2 |
| 3 | 2, 3 | Type B | 0 | 6 | 2 |
| 4 | 2, 3 | Type B | 0 | 8 | 2 |
| 5 | 2, 3 | Type B | 0 | 10 | 2 |
| 6 | Reserved | | | | |
| 7 | Reserved | | | | |
| 8 | 2, 3 | Type B | 0 | 2 | 4 |
| 9 | 2, 3 | Type B | 0 | 4 | 4 |
| 10 | 2, 3 | Type B | 0 | 6 | 4 |
| 11 | 2, 3 | Type B | 0 | 8 | 4 |
| 12 | 2, 3 | Type B | 0 | 10 | 4 |
| 13 (Note 1) | 2, 3 | Type B | 0 | 2 | 7 |
| 14 (Note 1) | 2 | Type A | 0 | 2 | 12 |
| | 3 | Type A | 0 | 3 | 11 |
| 15 (Note 1) | 2, 3 | Type A | 0 | 0 | 6 |
| 16 (Note 1) | 2, 3 | Type A | 0 | 2 | 6 |

Note 1:
The UE may assume that this PDSCH resource allocation is not used, if the PDSCH was scheduled with SI-RNTI in PDCCH Type0 common search space

Yet another method relates to configuring the same value for all BWPs in a cell.

In an embodiment of the disclosure, the UE may expect that a cell-common parameter will be configured for the first or second cell (the same parameter for all BWPs). Therefore, a HARQ-ACK codebook may be generated based on the cell-common parameter configured for the first or second cell.

For example, the first parameter may (maxNrofCodeWordsScheduledByDCI) be equally configured for all BWPs in a cell. That is, in case that there are two or more BPWs in a cell, the maxNrofCodeWordsScheduledByDCI value of the BWPs may be equally 1 or 2. Therefore, when the UE generates a HARQ-ACK codebook, parameters of the first and second cells may be determined based on the common value. That is, the UE may generate a HARQ-ACK codebook, based on the maxNrofCodeWordsScheduledByDCI value configured for any BWP of the first and second cells.

For example, the second parameter (TDRA table) may be equally configured for all BWPs in a cell. That is, in case that two or more BWPs are configured for a cell, the TDRA table of the BWPs may be identical. Alternatively, in case that two or more BWPs are configured for a cell, a cell-common TDRA table may be used. The cell-common TDRA table may be equally applied to BWPs in the cell. Therefore, when the UE generates a HARQ-ACK codebook, parameters of the first and second cells may be determined based on the common value. That is, a HARQ-ACK codebook may be generated based on the TDRA table value configured for any BWP of the first and second cells.

Yet another method relates to using the maximum/minimum value (or union/intersection) among values configured for BWPs in a cell.

In an embodiment of the disclosure, the UE may determine parameters, based on the maximum/minimum value (or union/intersection) among parameters configured for BWPs of the first or second cell. That is, the UE may have one or multiple BWPs configured for the first or second cell. The BWPs may have parameters necessary for HARQ-ACK codebook generation configured therefor. Therefore, the UE may generate a HARQ-ACK codebook of the first or second cell, based on the maximum/minimum value (or union/intersection) of parameters configured for the BWPs.

For example, the value of 1 or 2 may be configured for each BWP in the cell as the first parameter (maxNrofCodeWordsScheduledByDCI). The UE may generate a HARQ-ACK codebook of the first or second cell, based on the maximum value among values configured for respective BWPs (if the value of maxNrofCodeWordsScheduledByDCI of at least one BWP is 2, the maximum value is 2, and if maxNrofCodeWordsScheduledByDCI of all BWPs is 1, the maximum value is 1). In another method, the UE may generate a HARQ-ACK codebook of the first or second cell, based on the minimum value among values configured for respective BWPs (if the value of maxNrofCodeWordsScheduledByDCI of at least one BWP is 1, the maximum value is 1, and if maxNrofCodeWordsScheduledByDCI of all BWPs is 2, the maximum value is 2).

For example, the second parameter (TDRA table) may be configured for each BWP in the cell. The UE may generate a HARQ-ACK codebook of the first or second cell, based on the union of rows of the TDRA table configured for each BWP (rows included in the TDRA table of at least one BWP are included in HARQ-ACK codebook generation). In another method, the UE may generate a HARQ-ACK codebook of the first or second cell, based on the intersection among values configured for respective BWPs (rows configured commonly for all BWPs in the cell are included in HARQ-ACK codebook generation).

Yet another method relates to configuring parameter values for HARQ-ACK codebook generation of a deactivated cell or a cell having a dormant BWP activated.

In an embodiment of the disclosure, the UE may expect that necessary parameters will always be configured. That is, in the case of the first cell (deactivated cell), a parameter value may be configured such that, even if the cell is deactivated, the same can be used.

For example, the base station may configure, for the UE, a first parameter (maxNrofCodeWordsScheduledByDCI) value for the deactivated cell through an upper layer signal. The configured first parameter value may be used to generate a HARQ-ACK codebook in case that the cell is deactivated.

For example, the base station may configure, for the UE, a second parameter (TDRA table) for the deactivated cell through an upper layer signal. The configured second parameter value may be used to generate a HARQ-ACK codebook in case that the cell is deactivated.

For reference, the configured first and second parameters may not be used to receive a PDSCH. That is, the parameter values may be configured to generate HARQ-ACK codebook in the deactivated cell, and the configured parameters may not be applied to PDSCH reception.

In the case of the second cell (the dormant BWP of which is activated), the UE may configure a necessary parameter value in the dormant BWP.

For example, the base station may configure, for the UE, a first parameter (maxNrofCodeWordsScheduledByDCI) value in the dormant BWP through an upper layer signal. The configured first parameter value may be used to generate a HARQ-ACK codebook in case that the dormant BWP is activated.

For example, the base station may configure, for the UE, a second parameter (TDRA table) in the dormant BWP through an upper layer signal. The configured second parameter value may be used to generate a HARQ-ACK codebook in case that the dormant BWP is activated.

For reference, the configured first and second parameters may not be used to receive a PDSCH. That is, the parameter values may be configured to generate HARQ-ACK codebook of the dormant BWP, and the configured parameters may not be applied to PDSCH reception.

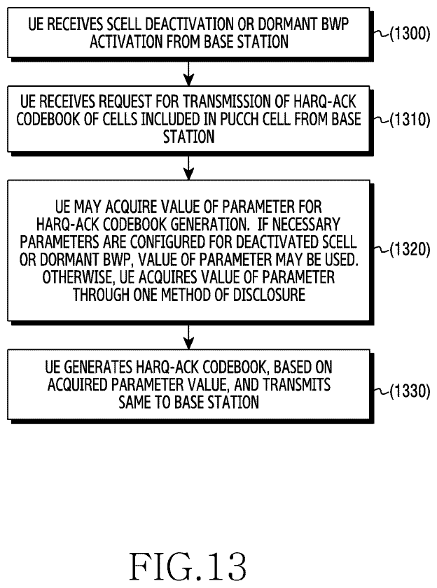

FIG. 13 illustrates a flowchart of a method for acquiring parameters according to an embodiment of the disclosure.

In the first step 1300, the UE may receive Scell deactivation or dormant BWP activation from the base station. The Scell may be deactivated, or the dormant BWP may be activated.

In the second step 1310, the UE may receive a request for transmission of a HARQ-ACK codebook of cells included in a PUCCH cell from the base station. The PUCCH cell may include the Scell of the first step. Therefore, the UE may generate a HARQ-ACK codebook including HARQ-ACK bits of the deactivated Scell or the Scell the dormant BWP of which has been activated.

In the third step 1320, the UE may acquire the value of a parameter for HARQ-ACK codebook generation. If necessary parameters are configure for the deactivated Scell or dormant BWP, the value of the parameter may be used. Otherwise, the UE may acquire the value of the parameter through an embodiment of the disclosure.

In the fourth step 1330, the UE may generate a HARQ-ACK codebook, based on the acquired parameter value, and may transmit the same to the base station.

In another embodiment methods for generating Type-3 HARQ-ACK during BWP change may be provided.

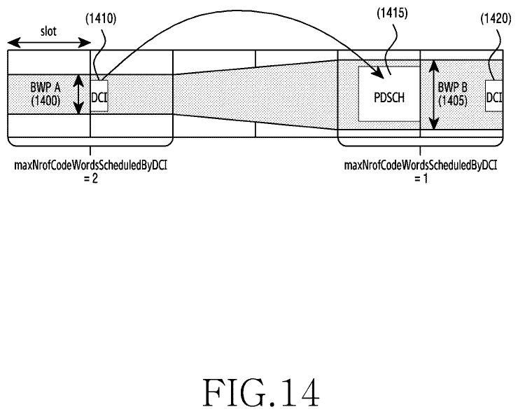

FIG. 14 illustrates a case in which a BWP change is indicated by DCI that schedules a PDSCH according to an embodiment of the disclosure.

Referring to FIG. 14, the UE may have multiple BWPs configured for one cell by the base station. Different maxNrofCodeWordsScheduledByDCI may be configured for respective configured BWPs. For example, two BWPs may be configured for one cell, 2 may be configured for BWP A as the value of maxNrofCodeWordsScheduledByDCI, and 1 may be configured for BWP B as the value of maxNrofCodeWordsScheduledByDCI.

The UE may perform PDSCH reception in BWP A 1400. The PDSCH received in BWP A may include a maximum of two transport blocks. Therefore, the UE may store HARQ-ACK information regarding a maximum of two transport blocks in one HARQ process number. The UE may receive DCI 1410 that indicates a BWP change at a specific timepoint. The DCI may indicate a change from BWP A to BWP B 1405. In BWP B, the UE may receive DCI 1420 that schedules a PDSCH, and the PDSCH may include a maximum of one transport block.

In the following description, BWP A may be a BWP prior to a BWP change, and BWP B may be a BWP after a BWP change.

The base station may instruct the UE to transmit a Type-3 HARQ-ACK codebook. The Type-3 HARQ-ACK codebook may be generated based on the configuration of the currently activated BWP of cells configured for the UE. Since BWP B is configured in the cell, the UE may generate a Type-3 HARQ-ACK codebook, based on the configuration of BWP B. For reference, 1 may be configured for BWP B as the value of maxNrofCodeWordsScheduledByDCI. Therefore, the Type-3 HARQ-ACK codebook of the cell in which BWP B is activated may include one bit of HARQ-ACK information per HARQ process number. However, BWP A which has been activated prior to BWP B activation has 2 configured as the value of maxNrofCodeWordsScheduledByDCI, and the UE may thus have two bits of HARQ-ACK information per HARQ process number stored therein. The UE must include two bits of HARQ-ACK information per HARQ process number in the Type-3 HARQ-ACK codebook. However, the Type-3 HARQ-ACK codebook may include only one bit of HARQ-ACK information per HARQ process number.

Methods for solving this are disclosed.

In the first method, the UE may include a NACK as one-bit HARQ-ACK information of a Type-3 HARQ-ACK codebook. That is, since the UE cannot include two bits of HARQ-ACK information in a Type-3 HARQ-ACK codebook which can include only one bit, the UE may determine that effective HARQ-ACK information cannot be transmitted, and may include a NACK in one bit of the Type-3 HARQ-ACK codebook. According to the first method, the UE may not include two bits of HARQ-ACK information in the Type-3 HARQ-ACK codebook. The base station is aware of the configuration of BWP A and BWP B, and may thus interpret that the one-bit NACK means that effective HARQ-ACK transmission is impossible, not a failure to receive a PDSCH (or transport block).

In the second method, the UE may transmit two bits of HARQ-ACK information stored in the UE as one-bit HARQ-ACK information of the Type-3 HARQ-ACK codebook, after spatial bundling thereof. For example, if all of the stored two bits of HARQ-ACK information are ACKs, an ACK may be transmitted as one-bit HARQ-ACK information of the Type-3 HARQ-ACK codebook. If any one of the stored two bits of HARQ-ACK information is a NACK, a NACK may be transmitted as one-bit HARQ-ACK information of the Type-3 HARQ-ACK codebook. Spatial bundling may be automatically performed by the UE even if the base station does not configure the same.

In the third method, the UE may transmit one bit of HARQ-ACK information among two bits of HARQ-ACK information stored in the UE as one-bit HARQ-ACK information of the Type-3 HARQ-ACK codebook. The UE may transmit a Type-3 HARQ-ACK codebook including one-bit HARQ-ACK information regarding the first transport block among the two bits of HARQ-ACK information. The UE may not include one-bit HARQ-ACK information regarding the second transport block among the two bits of HARQ-ACK information in the Type-3 HARQ-ACK codebook i.

In another method, when generating a Type-3 HARQ-ACK codebook, the UE may generate the Type-3 HARQ-ACK codebook, based on the largest value among maxNrofCodeWordsScheduledByDCI values configured for BWPs of the cell. That is, if 2 is configured as the maxNrofCodeWordsScheduledByDCI value for at least one BWP of one cell, the UE may generate a Type-3 HARQ-ACK codebook, based on the value of 2. If 1 is configured as the maxNrofCodeWordsScheduledByDCI value for all BWPs of one cell, the UE may generate a Type-3 HARQ-ACK codebook, based on the value of 1. This method may solve the problem in that the number of bits in the Type-3 HARQ-ACK codebook is varied by a BWP change.

In the above description, BWP A or B may be a dormant BWP. The DCI that indicates a BWP change may include a Scell dormancy indicator. In this case, either BWP A or B configured in the cell is a dormant BWP, and the UE may thus acquire a parameter in a method according to the previous embodiment, instead of acquiring a parameter (maxNrofCodeWordsScheduledByDCI) in BWP B for Type-3 HARQ-ACK codebook generation of the cell.

In the above description, the DCI that indicates a BWP change may be a MAC-CE that indicates Scell deactivation. In this case, there is no BWP B activated in the cell, and the UE may thus acquire a parameter in a method according to the previous embodiment, instead of acquiring a parameter (maxNrofCodeWordsScheduledByDCI) in BWP B for Type-3 HARQ-ACK codebook generation of the cell.

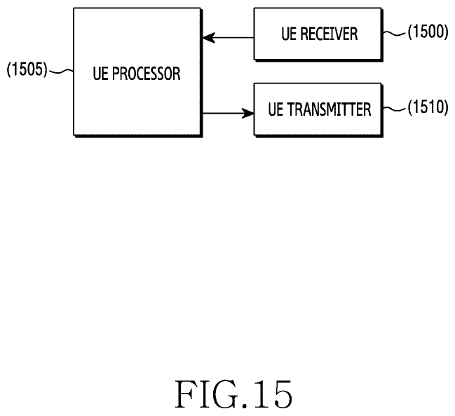

FIG. 15 illustrates a structure of a UE in a wireless communication system according to an embodiment of the disclosure.

Referring to FIG. 15, the UE may include a transceiver, which refers to a UE receiver 1500 and a UE transmitter 1510 as a whole, a memory (not illustrated), and a UE processor 1505 (or UE controller or processor). The UE transceiver 1500 and 1510, the memory, and the UE processor 1505 may operate according to the above-described communication methods of the UE. However, components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

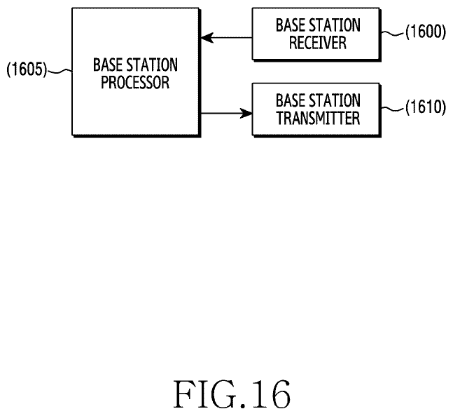

FIG. 16 illustrates a structure of a base station in a wireless communication system according to an embodiment of the disclosure.

Referring to FIG. 16, the base station may include a transceiver, which refers to a base station receiver 1600 and a base station transmitter 1610 as a whole, a memory (not illustrated), and a base station processor 1605 (or base station controller or processor). The base station transceiver 1600 and 1610, the memory, and the base station processor 1605 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the disclosure of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the disclosure and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, information with at least one cell associated with a hybrid automatic repeat request acknowledgement (HARQ-ACK) codebook transmission of the UE;
receiving, from the base station, information triggering the HARQ-ACK codebook transmission; and
transmitting, to the base station, a HARQ-ACK codebook including HARQ-ACK information associated with the at least one cell, respectively,
wherein, in case that the at least one cell includes at least one of a deactivated secondary cell (SCell) or an activated SCell including an activated dormant bandwidth part (BWP), HARQ-ACK information associated with the deactivated SCell and HARQ-ACK information associated with the activated SCell including the activated dormant BWP is generated based on a parameter associated with a HARQ-ACK information generation, which is configured for a reference BWP.

2. The method of claim 1,
wherein the parameter associated with the HARQ-ACK information generation, which is configured for the reference BWP includes a parameter for a maximum number of transport blocks to be transmitted on a physical downlink shared channel (PDSCH) and a parameter for time domain resource allocation for which the PDSCH is to be scheduled,
wherein a BWP corresponding to a BWP identifier indicating a BWP which is initially activated in case that a deactivated cell is activated is configured as the reference BWP for the deactivated SCell, and
wherein a BWP corresponding to a BWP identifier indicating a BWP which is activated in case that information indicating SCell dormancy is received outside an active time or a BWP corresponding to a BWP identifier indicating a BWP which is activated in case that the information indicating the SCell dormancy is received within the active time is configured as the reference BWP for the activated SCell including the activated dormant BWP.

3. The method of claim 2,
wherein the reference BWP for the deactivated SCell is a dormant BWP, the BWP corresponding to the BWP identifier indicating the BWP which is activated in case that information indicating the SCell dormancy is received outside the active time or the BWP corresponding to the BWP identifier indicating the BWP which is activated in case that the information indicating the SCell dormancy is received within the active time is configured as the reference BWP for the deactivated SCell.

4. The method of claim 1, further comprising:
receiving, from the base station, information indicating a change from a first BWP to a second BWP for a specific cell among the at least one cell,
wherein, in case that a maximum number of transport blocks to be transmitted on a PDSCH associated with the first BWP is greater than a maximum number of transport blocks to be transmitted on a PDSCH associated with the second BWP, HARQ-ACK information associated with the second BWP is configured to include a part of HARQ-ACK information associated with the first BWP which is generated before the information indicating the change from the first BWP to the second BWP is received.

5. A method performed by a base station in a wireless communication system, the method comprising:
transmitting, to a user equipment (UE), information with at least one cell associated with a hybrid automatic repeat request acknowledgement (HARQ-ACK) codebook transmission of the UE;
transmitting, to the UE, information triggering the HARQ-ACK codebook transmission; and
receiving, from the UE, a HARQ-ACK codebook including HARQ-ACK information associated with the at least one cell, respectively,
wherein, in case that the at least one cell includes at least one of a deactivated secondary cell (SCell) or an activated SCell including an activated dormant bandwidth part (BWP), HARQ-ACK information associated with the deactivated SCell and HARQ-ACK information associated with the activated SCell including the activated dormant BWP is generated based on a parameter associated with a HARQ-ACK information generation, which is configured for a reference BWP.

6. The method of claim 5,
wherein the parameter associated with the HARQ-ACK information generation, which is configured for the reference BWP includes a parameter for a maximum number of transport blocks to be transmitted on a physical downlink shared channel (PDSCH) and a parameter for time domain resource allocation for which the PDSCH is to be scheduled,
wherein a BWP corresponding to a BWP identifier indicating a BWP which is initially activated in case that a deactivated cell is activated is configured as the reference BWP for the deactivated SCell, and
wherein a BWP corresponding to a BWP identifier indicating a BWP which is activated in case that information indicating SCell dormancy is received outside an active time or a BWP corresponding to a BWP identifier indicating a BWP which is activated in case that the information indicating the SCell dormancy is received within the active time is configured as the reference BWP for the activated SCell including the activated dormant BWP.

7. The method of claim 6,
wherein the reference BWP for the deactivated SCell is a dormant BWP, the BWP corresponding to the BWP identifier indicating the BWP which is activated in case that information indicating the SCell dormancy is received outside the active time or the BWP corresponding to the BWP identifier indicating the BWP which is activated in case that the information indicating the SCell dormancy is received within the active time is configured as the reference BWP for the deactivated SCell.

8. The method of claim 5, further comprising:
transmitting, to the UE, information indicating a change from a first BWP to a second BWP for a specific cell among the at least one cell,
wherein, in case that a maximum number of transport blocks to be transmitted on a PDSCH associated with the first BWP is greater than a maximum number of transport blocks to be transmitted on a PDSCH associated with the second BWP, HARQ-ACK information associated with the second BWP is configured to include a part of HARQ-ACK information associated with the first BWP which is generated before the information indicating the change from the first BWP to the second BWP is received.

9. A user equipment (UE) in a wireless communication system, the UE comprising:
a transceiver; and
a controller couple with the transceiver and configured to:
receive, from a base station, information with at least one cell associated with a hybrid automatic repeat request acknowledgement (HARQ-ACK) codebook transmission of the UE,
receive, from the base station, information triggering the HARQ-ACK codebook transmission, and
transmit, to the base station, a HARQ-ACK codebook including HARQ-ACK information associated with the at least one cell, respectively,
wherein, in case that the at least one cell includes at least one of a deactivated secondary cell (SCell) or an activated SCell including an activated dormant bandwidth part (BWP), HARQ-ACK information associated with the deactivated SCell and HARQ-ACK information associated with the activated SCell including the activated dormant BWP is generated based on a parameter associated with a HARQ-ACK information generation, which is configured for a reference BWP.

10. The UE of claim 9,
wherein the parameter associated with the HARQ-ACK information generation, which is configured for the reference BWP includes a parameter for a maximum number of transport blocks to be transmitted on a physical downlink shared channel (PDSCH) and a parameter for time domain resource allocation for which the PDSCH is to be scheduled,
wherein a BWP corresponding to a BWP identifier indicating a BWP which is initially activated in case that a deactivated cell is activated is configured as the reference BWP for the deactivated SCell, and
wherein a BWP corresponding to a BWP identifier indicating a BWP which is activated in case that information indicating SCell dormancy is received outside an active time or a BWP corresponding to a BWP identifier indicating a BWP which is activated in case that the information indicating the SCell dormancy is received within the active time is configured as the reference BWP for the activated SCell including the activated dormant BWP.

11. The UE of claim 10,
wherein the reference BWP for the deactivated SCell is a dormant BWP, the BWP corresponding to the BWP identifier indicating the BWP which is activated in case that information indicating the SCell dormancy is received outside the active time or the BWP corresponding to the BWP identifier indicating the BWP which is activated in case that the information indicating the SCell dormancy is received within the active time is configured as the reference BWP for the deactivated SCell.

12. The UE of claim 9,
wherein the controller is further configured to:
receive, from the base station, information indicating a change from a first BWP to a second BWP for a specific cell among the at least one cell,
wherein, in case that a maximum number of transport blocks to be transmitted on a PDSCH associated with the first BWP is greater than a maximum number of transport blocks to be transmitted on a PDSCH associated with the second BWP, HARQ-ACK information associated with the second BWP is configured to include a part of HARQ-ACK information associated with the first BWP which is generated before the information indicating the change from the first BWP to the second BWP is received.

13. A base station in a wireless communication system, the base station comprising:
a transceiver; and
a controller couple with the transceiver and configured to:
transmit, to a user equipment (UE), information with at least one cell associated with a hybrid automatic repeat request acknowledgement (HARQ-ACK) codebook transmission of the UE,
transmit, to the UE, information triggering the HARQ-ACK codebook transmission, and
receiving, from the UE, a HARQ-ACK codebook including HARQ-ACK information associated with the at least one cell, respectively,
wherein, in case that the at least one cell includes at least one of a deactivated secondary cell (SCell) or an activated SCell including an activated dormant bandwidth part (BWP), HARQ-ACK information associated with the deactivated SCell and HARQ-ACK information associated with the activated SCell including the activated dormant BWP is generated based on a parameter associated with a HARQ-ACK information generation, which is configured for a reference BWP.

14. The base station of claim 13,
wherein the parameter associated with the HARQ-ACK information generation, which is configured for the reference BWP includes a parameter for a maximum number of transport blocks to be transmitted on a physical downlink shared channel (PDSCH) and a parameter for time domain resource allocation for which the PDSCH is to be scheduled,
wherein a BWP corresponding to a BWP identifier indicating a BWP which is initially activated in case that a deactivated cell is activated is configured as the reference BWP for the deactivated SCell, and
wherein a BWP corresponding to a BWP identifier indicating a BWP which is activated in case that information indicating SCell dormancy is received outside an active time or a BWP corresponding to a BWP identifier indicating a BWP which is activated in case that the information indicating the SCell dormancy is received within the active time is configured as the reference BWP for the activated SCell including the activated dormant BWP.

15. The base station of claim 14,
wherein the reference BWP for the deactivated SCell is a dormant BWP, the BWP corresponding to the BWP identifier indicating the BWP which is activated in case that information indicating the SCell dormancy is received outside the active time or the BWP corresponding to the BWP identifier indicating the BWP which is activated in case that the information indicating the SCell dormancy is received within the active time is configured as the reference BWP for the deactivated SCell.

16. The base station of claim 13,
wherein the controller is further configured to:
transmit, to the UE, information indicating a change from a first BWP to a second BWP for a specific cell among the at least one cell,
wherein, in case that a maximum number of transport blocks to be transmitted on a PDSCH associated with the first BWP is greater than a maximum number of transport blocks to be transmitted on a PDSCH associated with the second BWP, HARQ-ACK information associated with the second BWP is configured to include a part of HARQ-ACK information associated with the first BWP which is generated before the information indicating the change from the first BWP to the second BWP is received.
